(19) United States
(12) Patent Application Publication
(10) Pub. No.: US 2004/0184775 A1
(43) Pub. Date: Sep. 23, 2004

(54) Recording/reproducing apparatus, recording/reproducing method, computer program providing medium, and recording medium

(75) Inventors: Tadashi Nakamura, Nara-shi (JP); Yasumori Hino, Ikoma-shi (JP); Yasuyuki Kurosawa, Katano-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 10/767,068

(22) Filed: Jan. 28, 2004

(30) Foreign Application Priority Data
Jan. 31, 2003 (JP) 2003-024545

(51) Int. Cl. H04N 5/781

(52) U.S. Cl. 386/69; 386/125

(57) ABSTRACT

There is provided file management capable of recovering a reference relationship easily even when a path name is changed while a file is being referred to using the path name. In a recording/reproducing apparatus for managing information to be recorded/reproduced as files, using file system information having a directory hierarchical structure that can be referred to by a path name, and managing directories and files, using contents management information containing object management information referred to by object reference information on the path name, when information on a recording medium is updated by a recording/reproducing part, information on the update (e.g., a unique ID) is recorded in both the file system information and the object management information.

### BACKGROUND OF THE INVENTION

1. Field of the Invention

The present invention relates to a recording/reproducing apparatus, a recording/reproducing method, a computer program providing medium, and a recording medium. In particular, the present invention relates to a recording/reproducing apparatus and a recording/reproducing method for recording image data and audio data on a recording medium as a file; a providing medium storing a computer program for embodying the recording/reproducing apparatus and the recording/reproducing method by a computer; and a recording medium recorded by the recording/reproducing apparatus or the recording/reproducing method.

2. Description of the Related Art

Recently, AV data such as video information, still image information, audio information, and the like often are digitized to be recorded/reproduced. Examples of recording media for accumulating such digital information include a semiconductor memory such as a flash memory, a disk medium such as a DVD, a hard disk, and a minidisk (MD), etc.

AV data encoded by an encoding scheme such as MPEG2 and JPEG are recorded/reproduced with respect to the above-mentioned recording media. In recording such AV data, each AV data is managed on a file by a file system, and is reproduced by being specified on a file basis.

The above-mentioned semiconductor media and disk media have excellent characteristics such as random accessibility. An example of a technique of using random accessibility includes a programmed reproducing function.

For example, in a recording/reproducing system disclosed in JP 2002-10215 A, AV data is recorded as a file called a media object, and a plurality of media objects are recorded under a directory called a program. Due to such a recording format, a plurality of the programs can be created on a recording medium.

Furthermore, information called program information (PRG_INFO) is managed with respect to each program, and recorded on a recording medium as a file different from a media object. By referring to information on a media object to be registered in PRG_INFO, the order of reproducing AV files recorded on a recording medium can be controlled freely.

The above-mentioned function generally is called “programmed reproduction”, and is realized by using random accessibility in disk media.

Thus, in the case where AV data is recorded as a media object, and a program for referring to the media object also is recorded as a file (program file), reference information from the program file to the media object is required. As a format of the reference information, path information with respect to a file (i.e., information representing the name and hierarchical position of the file in a file system managing files) generally is used.

Herein, FIG. 30 shows an exemplary relationship between media objects and program files. FIG. 30 illustrates a directory structure of media objects and a program file structure.

Each program file holds the reference to each media object as a format of a full-path name from a ROOT directory. In FIG. 30, a path delimiter is described as “/”.

The above-mentioned media objects and program files are all managed by using a file system such as a UDF and a FAT. The file system generally is used in an architecture of a personal computer (hereinafter, referred to as a “PC”). Introducing the file system makes it easy to create application software on a PC for editing or reproducing the above-mentioned program files.

Although the above-mentioned PC architecture is excellent in the extensibility and the degree of freedom of a system, it is difficult to assume a fixed system environment. More specifically, the following situation often occurs: application software present in a PC environment of a certain user is not present in a PC environment of another user. In addition to software, an apparatus for recording/reproducing information with respect to disk media often is connected to a PC with an external digital interface such as a USB, and a recording/reproducing apparatus often is attached/detached or connected to a plurality of PCs.

Therefore, assuming that there is a disk medium 5100 storing data as shown in FIG. 30, even if application software capable of correctly handling directory information and program information is present in a PC environment of a certain user, it is not assured that such application software is present in another environment.

For example, as shown in FIG. 31, it is assumed that there is no application software. In a PC 5200, an operating system 5201 and a general-purpose file system processing part 5202 are operated. Furthermore, it is assumed that the PC 5200 is connected to a drive device 5204 by a digital interface 5203 such as a USB and an ATAPI, and information is recorded/reproduced with respect to the disk medium 5100 using the connected drive device 5204.

On the disk medium 5100, a plurality of files and directories (directory/media objects 5004) are managed by file system information 5300, and a plurality of the files are referred to by a program file 5002 as described above

In such a case, the PC 5200 can operate a directory and a file with respect to the disk medium 5100 via the file system processing part 5202. More specifically, the PC 5200 can change a path name, delete a file, add a file, etc.

In the case where a path name of a predetermined file referred to from the program file 5002 is changed in accordance with the user's instruction or the like, the file whose path name has been changed cannot be referred to from the program file 5002. For example, in FIG. 30, a path name of the file 5001 is “/PRG001/MOV001.MPG”. If this path name is changed to “/PRG100/MOV001.MPG”, the new path name is not matched with the reference information 5003 in the program file 5002, which makes it impossible to perform normal reproduction of the program file 5002.

In this case, in spite of the fact that the contents included in the file “MOV001.MPG” have not been changed at all, the mere change of the path name makes it impossible to reproduce a program, which degrades the convenience for a user.

Furthermore, a reference relationship that has been lost cannot be recovered easily. For example, it is required for a user to specify a reference relationship again, which is a burden on the user.

### SUMMARY OF THE INVENTION

One possible recording/reproducing apparatus according to the present invention includes: a recording/reproducing part for recording or reproducing information with respect to a recording medium; a file system information processing part for managing the information to be recorded or reproduced by the recording/reproducing part as a file, using file system information having a directory hierarchical structure capable of being referred to by a path name; and a contents management information processing part for managing the directory and the file, using contents management information containing object management information referred to by object reference information on the path name, wherein, when information on the recording medium is updated by the recording/reproducing part, the file system information processing part records information on the update in the file system information, and the contents management information processing part records the same information as the information on the update in the object management information.

Herein, the term “update” of information on a recording medium refers to any change regarding information on a recording medium, and includes, for example, adding a new directory or file, deleting a directory or a file, changing the name of a directory or a file, changing only the contents of a directory or a file without changing the name thereof, and the like.

According to the present invention, a recording/reproducing apparatus and a recording/reproducing method can be provided, which realize file management in which a reference relationship can be recovered easily even if a path name is changed while a file is being referred to, using the path name.

These and other advantages of the present invention will become apparent to those skilled in the art upon reading and understanding the following detailed description with reference to the accompanying figures.

### BRIEF DESCRIPTION OF THE DRAWINGS

FIG. 1 illustrates an outer appearance of an interface between a recording/reproducing apparatus according to Embodiment 1 of the present invention and related equipment.

FIG. 2 is a block diagram showing a function of the recording/reproducing apparatus according to Embodiment 1 of the present invention.

FIG. 3 illustrates a recording/reproducing operation of the recording/reproducing apparatus according to Embodiment 1 of the present invention.

FIG. 4A is a diagram showing a recording area of a recordable disk medium 100; and FIG. 4B is a diagram illustrating the arrangement in a horizontal direction of a lead-in area, a lead-out area, and a data area represented in a concentric shape in FIG. 4A

FIG. 5 is a diagram showing a logical data space of a disk medium 100 composed of logical sectors.

FIG. 6 is a diagram showing a hierarchical structure of directories and files to be recorded on the disk medium 100.

FIG. 7 is a diagram showing a data structure for managing a directory hierarchy under a UDF specification.

FIG. 8A is a diagram illustrating a data structure of a file entry defined by the UDF specification; and FIG. 8B is a diagram illustrating a data structure of a File Identifier Descriptor defined by the UDF specification.

FIG. 9A is a diagram showing an address space on the disk medium 100; and FIG. 9B is a diagram showing a state where data accumulated in a track buffer is supplied to a decoder, whereby AV data can be reproduced continuously.

FIG. 10 is a diagram showing a hierarchical structure of data to be recorded on the disk media 100, a system control part 104 for processing the data, and an internal structure of the system control part 104.

FIG. 11 is a diagram illustrating a data structure of a media object manager 320 in the recording/reproducing apparatus according to Embodiment 1 of the present invention.

FIG. 12 is a diagram illustrating a data structure of object management information (MO_INFO) 700 in the recording/reproducing apparatus according to Embodiment 1 of the present invention.

FIG. 13A is a diagram illustrating values to be set in MoType 710; and FIG. 13B is a diagram illustrating a conversion rule for setting a value in an OBJ_ID type field.

FIG. 14 is a diagram illustrating a data structure of a program manager 330 in the recording/reproducing apparatus according to Embodiment 1 of the present invention.

FIG. 15 is a diagram illustrating a data structure of program information (PRG_INFO) 800 in the recording/reproducing apparatus according to Embodiment 1 of the present invention.

FIG. 16 is a diagram showing an exemplary relationship between the directories and media objects, and the MO_INFO700.

FIG. 17 is a diagram showing an exemplary relationship of the program manager 330 with respect to the media object manager 320.

FIG. 18 is a diagram showing an exemplary relationship between the directories and media objects, and the MO_INFO 700 after a directory name is changed.

FIG. 19 is a diagram showing an exemplary relationship between the directories and media objects, and the MO_INFO 700 after a directory and a file are added.

FIG. 20 is a diagram showing an exemplary relationship between the directories and media objects, and the MO_INFO 700 after the media object manager 320 is recovered.

FIG. 21 is a diagram illustrating a data structure of object management information (MO_INFO) 2000 in the recording/reproducing apparatus according to Embodiment 2 of the present invention.

FIG. 22A is a diagram showing a data structure of Implementation Use Extended Attribute defined by the UDF specification; and FIG. 22B is a diagram showing a data structure of an extended attribute to be stored in Implementation Use 2100.

FIG. 23 is a diagram showing a data structure of a Logical Volume Integrity Descriptor defined by the UDF specification.

FIG. 24A is a diagram showing a data structure of a Logical Volume Header Descriptor of Logical Volume Contents Use contained in the Logical Volume Integrity Descriptor; and FIG. 24B is a diagram showing a data structure of Implementation Use contained in the Logical Volume Integrity Descriptor.

FIG. 25 is a diagram illustrating a data structure of the media object manager 320 in a recording/reproducing apparatus according to Embodiment 3 of the present invention.

FIG. 26 is a block diagram showing an exemplary configuration in the case where the recording/reproducing apparatus according to the present invention is implemented as a recorder.

FIG. 27 is a block diagram showing an exemplary configuration in the case where the recording/reproducing apparatus according to the present invention is implemented as a video camera.

FIG. 28 is a block diagram showing an exemplary configuration in the case where the recording/reproducing apparatus according to the present invention is implemented as a personal computer.

FIG. 29 is a diagram showing an exemplary relationship between a media object manager and a program manager.

FIG. 30 is a diagram showing an exemplary relationship between conventional directories and media objects, and a program file 5002.

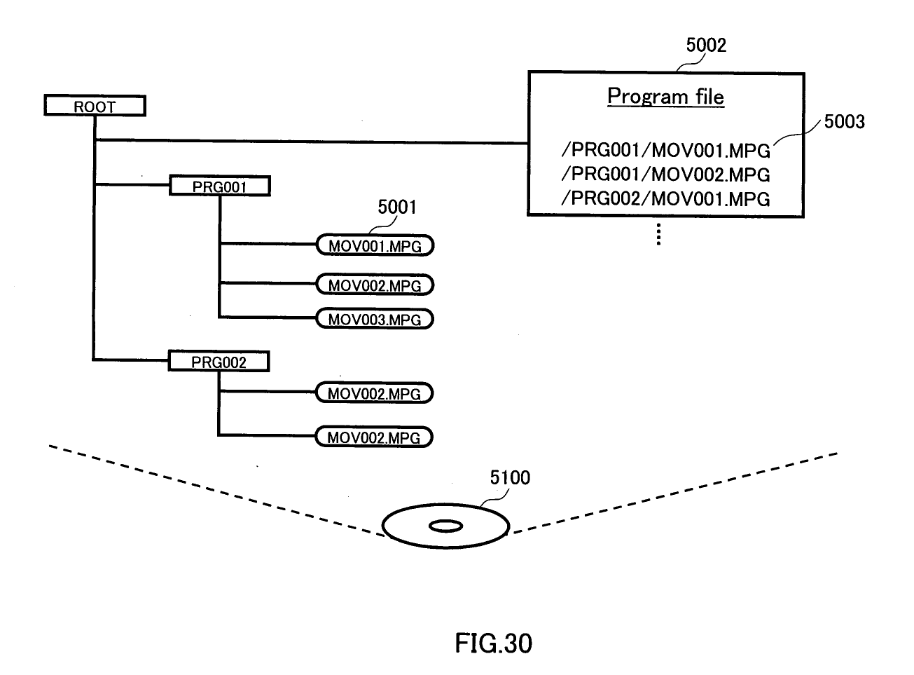

FIG. 31 is a diagram showing a hierarchical structure of data to be recorded on a conventional disk medium 5100, a personal computer 5200 for processing the data, and an internal structure of the personal computer 5200.

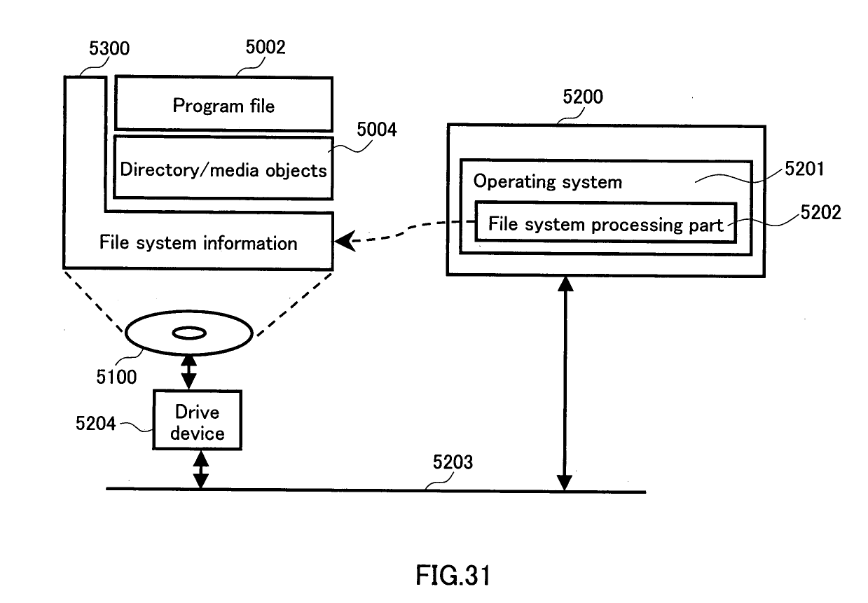

### DESCRIPTION OF THE PREFERRED EMBODIMENTS

A recording/reproducing apparatus according to the present invention includes: a recording/reproducing part for recording or reproducing information with respect to a recording medium; a file system information processing part for managing the information to be recorded or reproduced by the recording/reproducing part as a file, using file system information having a directory hierarchical structure capable of being referred to by a path name; and a contents management information processing part for managing the directory and the file, using contents management information containing object management information referred to by object reference information on the path name. When information on the recording medium is updated by the recording/reproducing part, the file system information processing part records information on the update in the file system information, and the contents management information processing part records the same information as the information on the update in the object management information.

In the above-mentioned configuration, it is preferable that, in a case where a new directory or a new file is recorded on the recording medium, the directory or the file is assigned a unique ID that is identification information not duplicated on the recording medium, and the assigned unique ID is used as the information on the update. Furthermore, it is preferable that the file system information processing part records the unique ID in an extended attribute in a file entry managing a structure of the directory or the file, and the contents management information processing part records the unique ID in the object management information so that the unique ID is associated with object reference information.

A value of the unique ID may be determined by the file system information processing part or the contents management information processing part.

Furthermore, it is preferable that, in a case where the directory or the file referred to by the object reference information is detected not to be present in the directory hierarchy, the contents management information processing part searches the file system information for the same value as that of the unique ID recorded in the object management information, and when a directory or a file assigned the same value as that of the unique ID is detected, the contents management information processing part sets new object reference information in the object management information with respect to a path name of the directory or the file assigned the same value as that of the unique ID.

In the recording/reproducing apparatus with the above-mentioned configuration, it is preferable that, in a case where the directory or the file referred to by the object reference information is detected not to be present in the directory hierarchy, the contents management information processing part searches the file system information for the same value as that of the unique ID recorded in the object management information, and when a directory or a file assigned the same value as that of the unique ID is not detected, the contents management information processing part deletes the object management information from the contents management information.

In the recording/reproducing apparatus with the above-mentioned configuration, it is preferable that, in a case where information in a volume managed by the file system information is updated by the recording/reproducing part on the recording medium, the file system information processing part updates volume update information contained in volume structure information managed by the file system information, and the contents management information processing part records the same information as the volume update information in the contents management information.

According to the above-mentioned configuration, by recording particular information in volume structure information contained in file system information, in contents management information, it becomes possible to easily detect inconsistency between the file system information and the contents management information.

It is preferable that the volume update information includes at least one selected from the group consisting of:

(1) information representing a last update date and time of the volume;

(2) information representing a maximum value of a unique ID that is identification information not duplicated on the recording medium, contained in the file system information;

(3) a total number of files contained in the file system information; and

(4) a total number of directories contained in the file system information.

Furthermore, it is preferable that, in a case where the volume update information contained in the volume structure information managed by the file system information is not matched with the information in the contents management information, the contents management information processing part searches the file system information for the same value as that of the unique ID recorded in the object management information, and when a directory or a file assigned the same value as that of the unique ID is detected, the contents management information processing part sets new object reference information in the object management information with respect to a path name of the directory or the file assigned the same value as that of the unique ID.

It is preferable that, in a case where the volume update information contained in the volume structure information managed by the file system information is not matched with the information in the contents management information, the contents management information processing part searches the file system information for the same value as that of the unique ID recorded in the object management information, and when a directory or a file assigned the same value as that of the unique ID is not detected, the contents management information processing part deletes the object management information from the contents management information.

It is preferable that, in a case where the volume update information contained in the volume structure information managed by the file system information is not matched with the information in the contents management information, the recording/reproducing part stops recording of a new directory or a new file on the recording medium.

Furthermore, in order to achieve the above-mentioned object, in a recording/reproducing method according to the present invention for recording or reproducing information with respect to a recording medium with a recording/reproducing apparatus, the information recorded or reproduced with respect to the recording medium is managed as a file, using file system information having a directory hierarchical structure capable of being referred to by a path name, and the directory and the file are managed, using contents management information containing object management information referred to by object reference information on the path name. The recording/reproducing method includes: when information on the recording medium is updated by the recording/reproducing apparatus, recording information on the update in the file system information; and recording the information on the update in the object management information.

It is preferable that the above-mentioned recording/reproducing method further includes, in a case where a new directory or a new file is recorded on the recording medium, assigning a unique ID that is identification information not duplicated on the recording medium to the directory or the file, wherein the assigned unique ID is used as the information on the update in two processes of recording the information on the update. Furthermore, it is preferable that, in assigning the unique ID, a value of the unique ID is determined so as not to be duplicated in the file system information. Alternatively, it also is preferable that, in assigning the unique ID, a value of the unique ID is determined so as not to be duplicated in the contents management information.

It is preferable that the above-mentioned recording/reproducing method further includes detecting whether or not the directory or the file referred to by the object reference information is present in the directory hierarchy, and the method further includes: in a case where the directory or the file referred to by the object reference information is detected not to be present in the directory hierarchy, searching the file system information for the same value as that of the unique ID recorded in the object management information; and when a directory or a file assigned the same value as that of the unique ID is detected, setting new object reference information in the object management information with respect to a path name of the directory or the file assigned the same value as that of the unique ID.

It is preferable that the above-mentioned recording/reproducing method further includes detecting whether or not the directory or the file referred to by the object reference information is present in the directory hierarchy, and the method further includes: in a case where the directory or the file referred to by the object reference information is detected not to be present in the directory hierarchy, searching the file system information for the same value as that of the unique ID recorded in the object management information; and when a directory or a file assigned the same value as that of the unique ID is not detected, deleting the object management information from the contents management information.

Furthermore, the above-mentioned recording/reproducing method further includes: in a case where information in a volume managed by the file system information is updated by the recording/reproducing apparatus on the recording medium, updating volume update information contained in volume structure information managed by the file system information; and recording the same information as the volume update information in the contents management information.

Furthermore, it is preferable that the volume update information includes at least one selected from the group consisting of:

(1) information representing a last update date and time of the volume;

(2) information representing a maximum value of a unique ID that is identification information not duplicated on the recording medium, contained in the file system information;

(3) a total number of files contained in the file system information; and

(4) a total number of directories contained in the file system information.

It is preferable that the above-mentioned recording/reproducing method further includes confirming whether or not the volume update information contained in the volume structure information managed by the file system information is matched with the information in the contents management information, and the method further includes: in a case where the information is not matched, searching the file system information for the same value as that of the unique ID recorded in the object management information; and when a directory or a file assigned the same value as that of the unique ID is detected, setting new object reference information in the object management information with respect to a path name of the directory or the file assigned the same value as that of the unique ID.

It is preferable that the above-mentioned recording/reproducing method further includes confirming whether or not the volume update information contained in the volume structure information managed by the file system information is matched with the information in the contents management information, and the method further includes: in a case where the information is not matched, searching the file system information for the same value as that of the unique ID recorded in the object management information; and when a directory or a file assigned the same value as that of the unique ID is not detected, deleting the object management information from the contents management information.

It is preferable that the above-mentioned recording/reproducing method further includes confirming whether or not the volume update information contained in the volume structure information managed by the file system information is matched with the information in the contents management information, and the method further includes: in a case where the information is not matched, stopping recording of a new directory or a new file on the recording medium.

A computer program providing medium according to the present invention stores a computer program that is read by a computer and allows the computer to function as a recording/reproducing apparatus for recording or reproducing information with respect to a recording medium. The information recorded or reproduced with respect to the recording medium is managed as a file, using file system information having a directory hierarchical structure capable of being referred to by a path name, and the directory and the file are managed, using contents management information containing object management information referred to by object reference information on the path name. The computer program includes an instruction for allowing the computer to perform the processes of when information on the recording medium is updated by the computer, generating information on the update; recording the information on the update in the file system information; and recording the information on the update in the object management information.

By loading the computer program onto a computer from the computer program providing medium and allowing the computer to execute the program, file system information and contents management information hold information on an update. Because of this, a recording/reproducing apparatus can be realized as follows. Even if inconsistency occurs between the file system information and the contents management information as a result of inappropriate processing such as an operation of only the file system information, by comparing the “information on an update” of the file system information with that of the contents management information, a file and a directory in which an inappropriate operation is performed can be detected easily, and consistency between the file system information and the contents management information can be recovered easily.

In the above-mentioned computer program providing medium, it is preferable that the above-mentioned computer program further includes an instruction for allowing the computer to perform the process of, in a case where a new directory or a new file is recorded on the recording medium, assigning a unique ID that is identification information not duplicated on the recording medium to the directory or the file as the information on the update.

In the above-mentioned computer program providing medium, it is preferable that the computer program further includes an instruction for allowing the computer to perform the processes of: in a case where information in a volume managed by the file system information is updated by the computer on the recording medium, updating volume update information contained in volume structure information managed by the file system information; and recording the same information as the volume update information in the contents management information.

It is preferable that the above-mentioned computer program further includes an instruction for allowing the computer to perform the process of detecting whether or not the directory or the file referred to by the object reference information is present in the directory hierarchy, and in a case where the directory or the file referred to by the object reference information is detected not to be present in the directory hierarchy, searching the file system information for the same value as that of the unique ID recorded in the object management information; and when a directory or a file assigned the same value as that of the unique ID is detected, setting new object reference information in the object management information with respect to a path name of the directory or the file assigned the same value as that of the unique ID.

It is preferable that the above-mentioned computer program further includes an instruction for allowing the computer to perform the process of detecting whether or not the directory or the file referred to by the object reference information is present in the directory hierarchy, and in a case where the directory or the file referred to by the object reference information is detected not to be present in the directory hierarchy, searching the file system information for the same value as that of the unique ID recorded in the object management information; and when a directory or a file assigned the same value as that of the unique ID is not detected, deleting the object management information from the contents management information.

It is preferable that the above-mentioned computer program further includes an instruction for allowing the computer to perform the process of confirming whether or not the volume update information contained in the volume structure information managed by the file system information is matched with the information in the contents management information, and in a case where the information is not matched, searching the file system information for the same value as that of the unique ID recorded in the object management information; and when a directory or a file assigned the same value as that of the unique ID is detected, setting new object reference information in the object management information with respect to a path name of the directory or the file assigned the same value as that of the unique ID.

It is preferable that the above-mentioned computer program further includes an instruction for allowing the computer to perform the process of confirming whether or not the volume update information contained in the volume structure information managed by the file system information is matched with the information in the contents management information, and in a case where the information is not matched, searching the file system information for the same value as that of the unique ID recorded in the object management information; and when a directory or a file assigned the same value as that of the unique ID is detected, deleting the object management information from the contents management information.

It is preferable that the above-mentioned computer program further includes an instruction for allowing the computer to perform the process of confirming whether or not the volume update information contained in the volume structure information managed by the file system information is matched with the information in the contents management information, and in a case where the information is not matched, stopping recording of a new directory or a new file on the recording medium.

Furthermore, a recording medium according to the present invention stores file system information having a directory hierarchical structure capable of being referred to by a path name, for managing information to be recorded or reproduced as a file, and object management information referred to by object reference information on the path name, for managing the directory and the file, wherein the file system information and the object management information contain information on an update of the information to be recorded or reproduced.

It is preferable that the information on the update of the information to be recorded or reproduced is a unique ID as identification information assigned to an updated directory or file so as not to be duplicated with that of other directories or files on the recording medium.

Alternatively, the information on the update of the information to be recorded or reproduced may include at least one selected from the group consisting of

(1) information representing a last update date and time of the volume managed by the file system information on the recording medium;

(2) information representing a maximum value of a unique ID that is identification information not duplicated on the recording medium, contained in the file system information;

(3) a total number of files contained in the file system information; and

(4) a total number of directories contained in the file system information.

Hereinafter, a recording/reproducing apparatus, a recording/reproducing method, a providing medium storing a computer program for embodying the recording/reproducing method or a computer program for embodying the recording/reproducing method, and a recording medium recorded by the recording/reproducing apparatus or the recording/reproducing method according to embodiments of the present invention will be described with reference to the drawings.

Embodiment 1

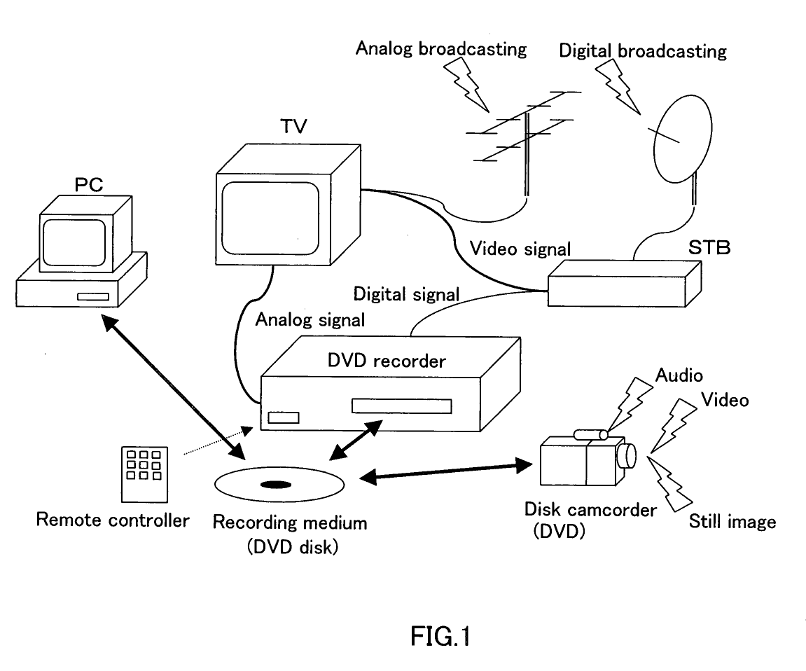

FIG. 1 is a diagram illustrating an outer appearance of an interface between a DVD recorder, which is an exemplary recording/reproducing apparatus according to Embodiment 1 of the present invention, and related equipment.

As shown in FIG. 1, in the DVD recorder, a DVD disk as a disk medium that is a recording medium is inserted, whereby video information and the like are recorded/reproduced. The DVD recorder generally is operated by a remote controller or a switch on the equipment.

Examples of video information input to the DVD recorder include an analog signal and a digital signal. There is analog broadcasting for an analog signal, and digital broadcasting for a digital signal. Generally, according to the analog broadcasting, a signal is received and decoded by a receiver built in a TV apparatus, and is input to the DVD recorder as an analog video signal of the NTSC format or the like.

According to the digital broadcasting, a signal is decoded to a digital signal at a set-top box (STB) that is a receiver, and is input and recorded in the DVD recorder.

On the other hand, video information recorded on a DVD disk is reproduced by the DVD recorder to be output outside. A signal to be output also is an analog signal or a digital signal in the same way as in a signal to be input. In the case where an output signal is an analog signal, the output signal directly is input to a TV apparatus. In the case where an output signal is a digital signal, the output signal is input to a TV apparatus after being converted to an analog signal via the STB, and is displayed on a TV as a video.

A DVD camcorder also is an apparatus using a DVD disk. The DVD camcorder is a combination of a DVD recorder and a camera apparatus having a lens and a CCD, which encodes a captured video signal to record it.

Video information also may be recorded/reproduced with respect to a DVD disk by a PC or the like, instead of a DVD recorder and a DVD camcorder. Even if video information is recorded on a DVD disk by a PC or the like, when the DVD disk is inserted into a DVD recorder, the DVD recorder reproduces the video information from the DVD disk.

Video information for the above-mentioned analog broadcasting and digital broadcasting generally is accompanied with audio information. The accompanying audio information also is recorded/reproduced by a DVD recorder in the same way as the video information.

Furthermore, video information may be a still image instead of a moving image. For example, this corresponds to the case where a still image is recorded with a photograph function of a DVD camcorder, or a still image is copied from another recording apparatus (hard disk) to a DVD disk on a PC.

As a digital interface between a DVD recorder and external equipment such as an STB, various interfaces are considered. Examples of the interfaces include IEEE 1394, ATAPI, SCSI, USB, and the like.

Furthermore, as a signal between a DVD recorder and a TV, an analog (composite) video signal of the NTSC format has been exemplified. However, as the signal between a DVD recorder and a TV, a component signal in which a luminance signal and a color-difference signal are transmitted separately may be used.

Furthermore, regarding a video transmission interface between AV equipment and a TV, replacing an analog interface by a digital interface (e.g., a DVI) has been studied and developed, and it necessarily is expected that a DVD recorder and a TV are connected to each other through a digital interface.

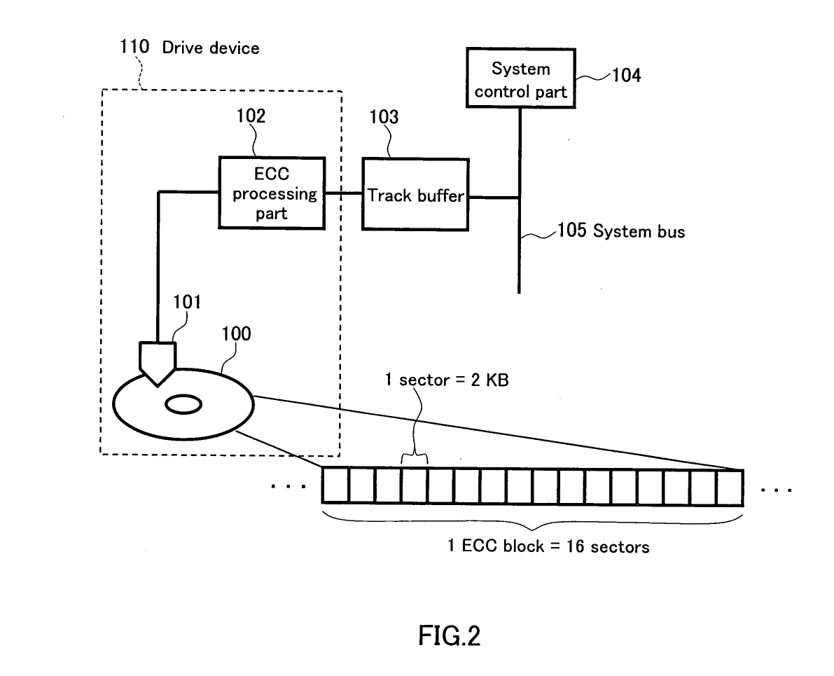

FIG. 2 is a block diagram showing functions of a recording/reproducing apparatus according to Embodiment 1 of the present invention and a drive device 110 incorporated in the recording/reproducing apparatus. In FIG. 2, the drive device 110 includes an optical pickup 101 that is recording/reproducing means, and an Error Correcting Code (ECC) processing part 102, and records/reproduces data with respect to a disk medium 100 that is a recording medium such as a DVD disk.

In the disk medium 100, data is recorded in a minimum unit called a sector. Furthermore, a plurality of sectors constitute one ECC block, and the ECC processing part 102 performs error correction using the ECC block as one unit. The ECC block also may be called an ECC cluster.

In the case of a DVD-RAM disk as an example of the disk medium 100, the size of a sector is 2 kilobytes, and 16 sectors constitute one ECC block. The size of a sector is varied depending upon the kind of the disk medium 100. One sector may be 512 bytes (B), 8 kilobytes (KB), etc.

Furthermore, regarding the ECC block, one sector may be configured as one ECC block. Alternatively, 16 sectors, 32 sectors, or the like may be configured as one ECC block. In the future, along with an increase in a recordable information capacity, the size of a sector and the number of sectors constituting an ECC block are expected to increase.

Furthermore, the drive device 110 is connected to a track buffer 103. The track buffer 103 is connected to a system control part 104 that controls the entire system of the recording/reproducing apparatus via a system bus 105.

The track buffer 103 is a buffer for recording AV data on the disk medium 100 more efficiently, and recording AV data at a variable bit rate (VBR). Although a read-write rate (Va) with respect to the disk medium 100 is fixed, a bit rate (Vb) of AV data is varied depending upon the complexity of the contents thereof (an image in the case of a video). Thus, the track buffer 103 absorbs the difference in a bit rate.

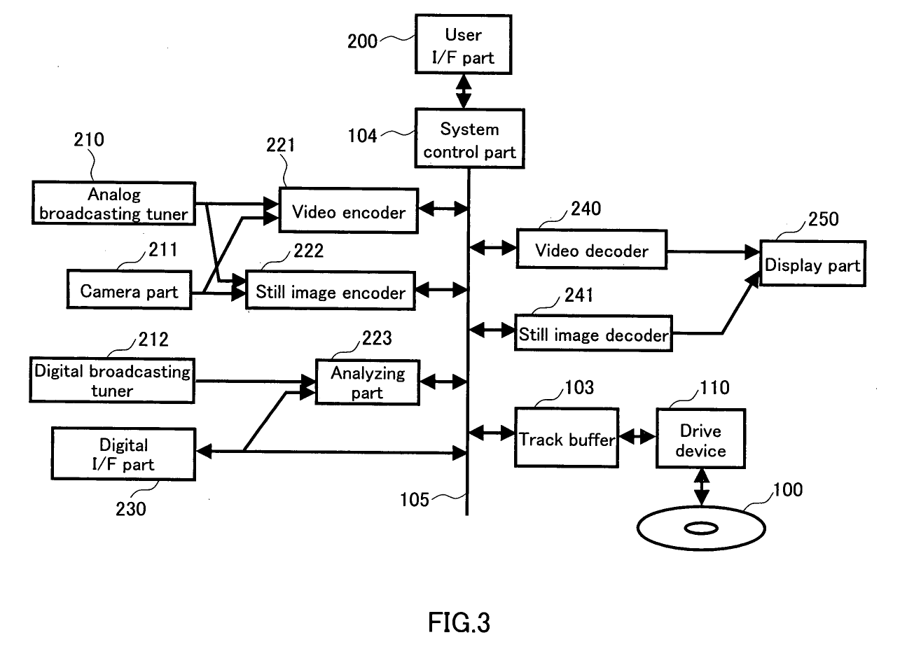

FIG. 3 is a block diagram showing the recording/reproducing apparatus according to Embodiment 1 of the present invention, including the drive device 110. As shown in FIG. 3, the recording/reproducing apparatus according to Embodiment 1 of the present invention includes a system control part 104 for managing and controlling the entire system, a user interface (I/F) part 200 for performing display to a user and receiving a request from the user, an analog broadcasting tuner 210 for receiving VHF and UHF signals, a camera part 211 for converting a video to an AV signal, a digital broadcasting tuner 212 for receiving a signal according to digital broadcasting, a video encoder 221 for converting an AV signal input to a digital signal and encoding the digital signal to an MPEG program stream or the like, a still image encoder 222 for encoding an AV signal input to a JPEG stream or the like, an analyzing part 223 for analyzing a broadcasted MPEG transport stream, a video decoder 240 for decoding video data of the MPEG or the like, a still image decoder 241 for decoding still image data, a display part 250 such as a TV and a loudspeaker, and the like.

The video decoder 240, the still image decoder 241, and the analyzing part 223 are connected to the analog broadcasting tuner 210, the camera part 211, the digital broadcasting tuner 212, and the like, as input sources of AV data.

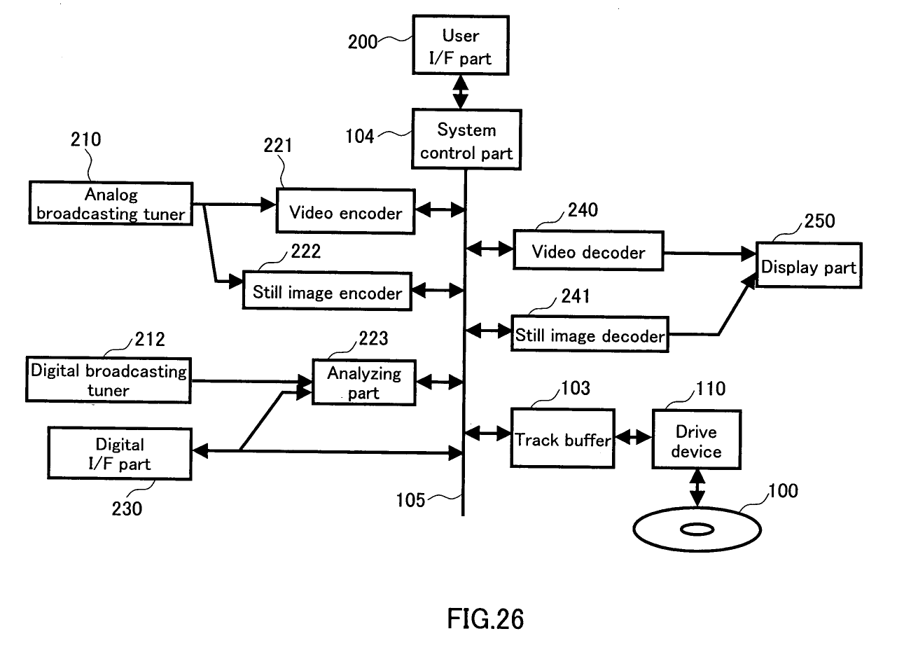

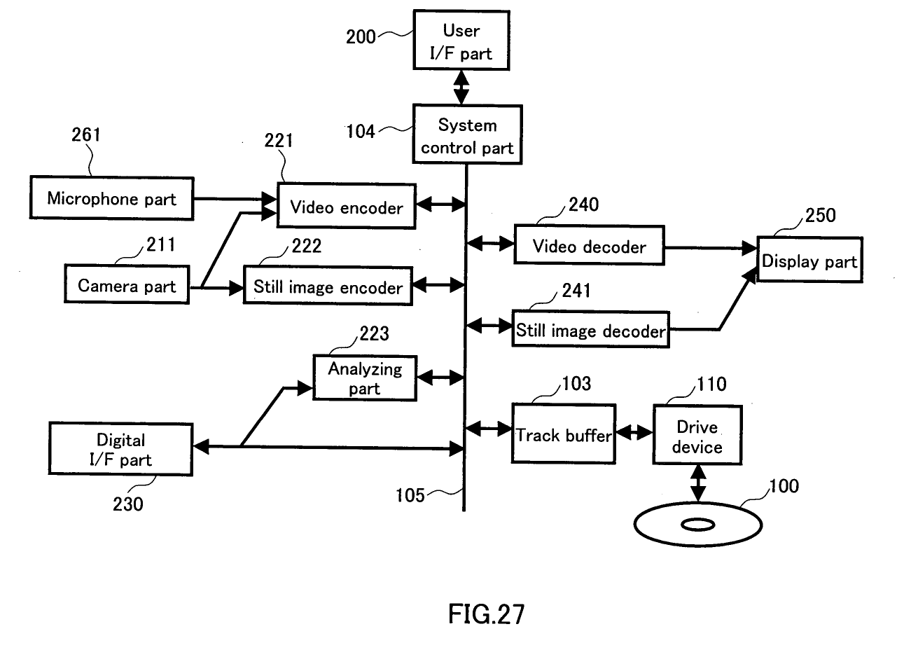

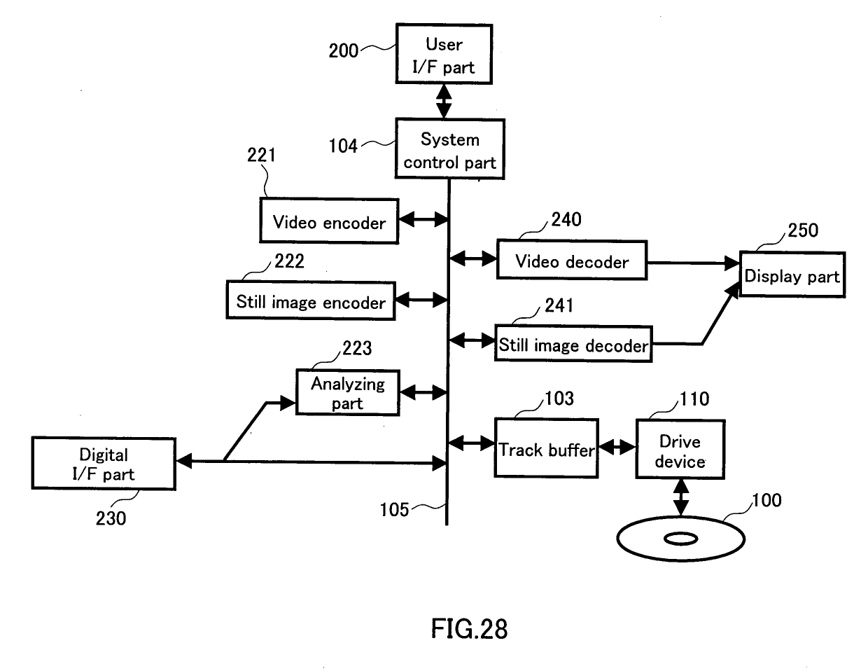

It is not required that all of the above-mentioned encoder, tuner, and camera part are provided simultaneously. Only the ones required in accordance with a use purpose of the recording/reproducing apparatus have to be provided. For example, in the case where the recording/reproducing apparatus is a recorder for an optical disk such as a DVD, the configuration shown in FIG. 3 with the camera part 211 omitted may be used, as shown in FIG. 26. In the case where the recording/reproducing apparatus is a video camera, the configuration shown in FIG. 3 with the analog broadcasting tuner 210 and the digital broadcasting tuner 212 omitted, and a microphone part 261 for collecting sound added thereto may be used, as shown in FIG. 27. Furthermore, in the case where the recording/reproducing apparatus is a personal computer, the configuration similar to that shown in FIG. 26 may be used. Alternatively, as shown in FIG. 28, the configuration shown in FIG. 3 with the analog broadcasting tuner 210, the camera part 211, and the digital broadcasting tuner 212 omitted may be used.

Furthermore, the recording/reproducing apparatus shown in FIG. 3 includes the track buffer 103 for temporarily storing written data, and the drive device 110 for writing data on the disk medium 100, as shown in FIG. 2.

The recording/reproducing apparatus also may include a digital interface (I/F) part 230 that is an interface for outputting data to external equipment by communication means such as IEEE 1394 and USB.

The detailed operation of the recording/reproducing apparatus according to Embodiment 1 of the present invention will be described later.

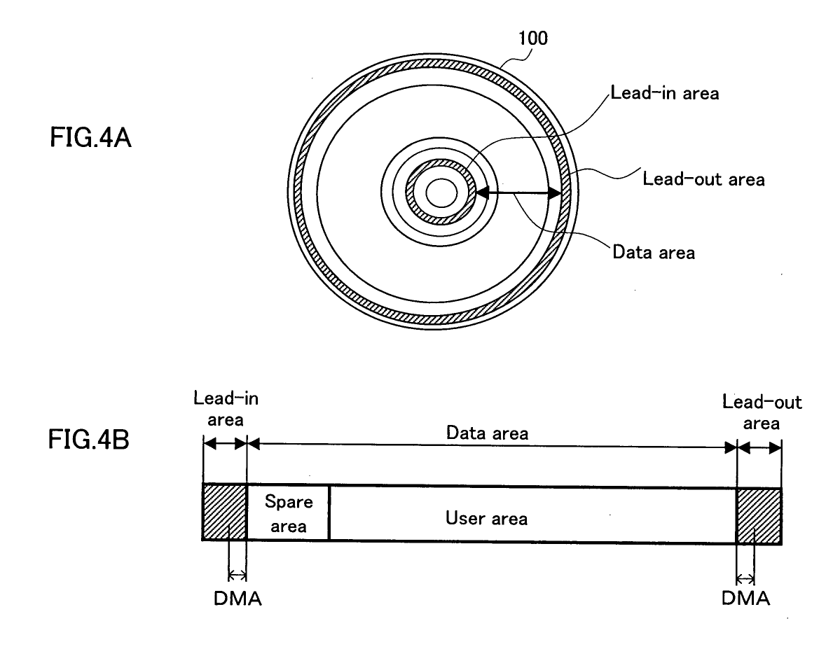

FIGS. 4A and 4B are diagrams showing an outer appearance and a physical structure of the recordable disk medium 100 in the recording/reproducing apparatus according to Embodiment 1 of the present invention. For example, a disk medium such as a DVD-RAM is inserted into the recording/reproducing apparatus while being accommodated in a cartridge for the purpose of protecting a recording surface. The recording surface may be protected in another configuration, and if acceptable, the disk medium may be inserted directly into the recording/reproducing apparatus without being accommodated in a cartridge.

FIG. 4A is a diagram showing an example of a recording area of the recordable disk medium 100. In the example shown in FIG. 4A, a lead-in area is placed on an innermost side, a lead-out area is placed on an outermost side, and a data area is placed between the lead-in area and the lead-out area. In the lead-in area, a reference signal required for stabilizing a servo when the optical pick-up 101 accesses the disk medium 100, an identification signal with respect to other media, and the like are recorded. In the lead-out area, a reference signal and the like similar to those in the lead-in area are recorded. The data area is divided into sectors that are minimum access units.

FIG. 4B illustrates the arrangement in a horizontal direction of the lead-in area, the lead-out area, and the data area shown in a concentric shape in FIG. 4A.

The lead-in area and the lead-out area respectively have a Defect Management Area (DMA) inside. The DMA is an area that stores position information representing the position of a defective sector, and alternate position information representing in which spare area (described later) a replacement sector for the defective sector is present.

Furthermore, the data area includes a spare area and a user area inside. The spare area is used as a replacement sector to replace a defective sector. The user area can be used for recording by a file system. Depending upon the kind, a disk medium may not have a spare area. In this case, if required, replacement processing of a defective sector may be performed in a file system such as the UDF (described later) and the like.

In order to access each sector in the data area, the data area generally is assigned Physical Sector Numbers (PSNs) successively from the inner side. A sector to be managed by the PSN is called a physical sector.

Furthermore, only sectors to be used for recording data among the physical sectors of the user area are assigned continuous Logical Sector Numbers (LSNs) successively from an inner side. A sector to be managed by the LSN is called a logical sector.

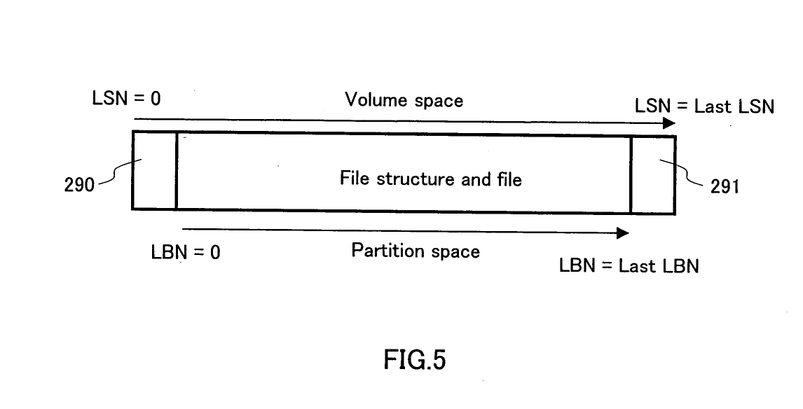

FIG. 5 is a diagram showing a logical data space of the disk medium 100 composed of logical sectors. The logical data space is called a volume space, and user data is recorded therein. In the volume space, recorded data is managed by the file system.

More specifically, information for managing a group of sectors storing data as a file and managing a group of files as a directory is recorded in a partition space in the volume space, and volume structure information 290 and its backup 291 for managing the partition space and the like are recorded at a leading edge and a trailing edge of the volume space.

In disk media such as a DVD-RAM, a file system is called a UDF, and those which comply with the ISO 13346 standard generally are used.

The above-mentioned one group of sectors is not necessarily placed continuously in the volume space, and may be discretely placed. Therefore, the file system manages one group of sectors placed continuously in the partition space among sector groups constituting a file, as an extent, and manages a file as a collection of related extents.

The partition space of the UDF is assigned Logical Block Numbers (LBNs) on the basis of a data access unit, whereby data is arranged and managed. A structure called a File Entry (FE) defined by the UDF specification for managing such extents will be described later.

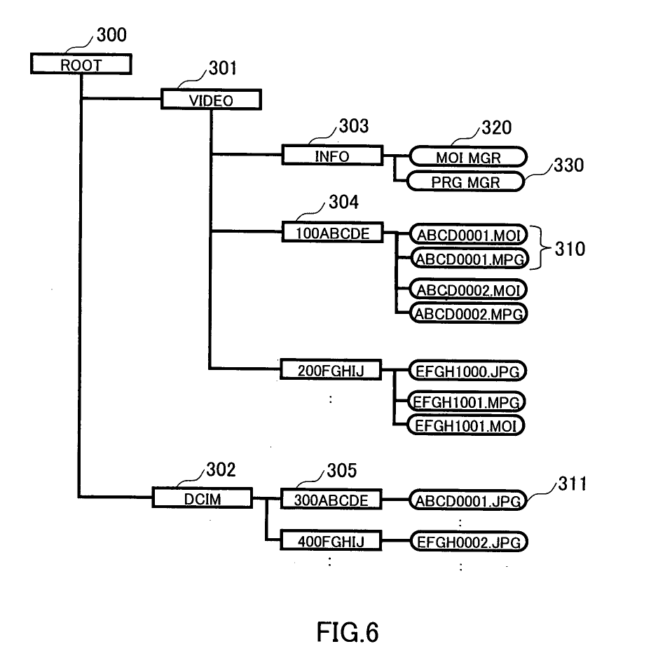

FIG. 6 is a diagram showing an example of a hierarchical structure of directories and files in the disk medium 100 recorded by the recording/reproducing apparatus according to Embodiment 1 of the present invention. As shown in FIG. 6, under a ROOT directory 300, there are hierarchical subdirectories (301 to 305, etc.), and under these subdirectories, various kinds of media objects (e.g., 310, 311) that are files containing video and still image data, a media object manager 320 (file name: MOI_MGR) that is a file for managing each media object, a program manager 330 (file name: PRG_MGR) for grouping a plurality of media objects and managing a reproducing order and classification information, and the like are stored.

In Embodiment 1, a directory hierarchy and file names of various kinds of media objects containing AV data to be recorded/reproduced will be described, using the DCF standard (described later) and formats similar thereto. The directory hierarchy and file-naming rule are not limited thereto, and other directory hierarchies and file-naming rules may be used.

Among the media objects, a video object containing video data of MPEG2 or the like is composed of a video file and an attribute information file. The video file is recorded in accordance with the following file-naming rule: the first four letters are a combination of arbitrary alphabet letters, and the subsequent “nnnn” is a decimal number, as in “ABCDnnnn.MPG”. The video file contains AV data compressed by the MPEG 2 system, MPEG 4 system, or the like, and is recorded as a file in a program stream (PS), a transport stream (TS), or other formats.

Furthermore, an attribute information file for recording attribute information regarding each video file is recorded as in “ABCDnnnn.MOI”. The attribute information file contains identification information of each video file, a recorded date and time, a representative image (thumbnail picture) of video data, access map information for converting a reproduction time of video data into a logical address on the disk medium 100, management information thereof, and the like. Due to the access map information, a time axis of video data and a data (bit string) axis can be converted therebetween, and a random access can be performed based on a time axis with respect to video data. The attribute information file may have a format complying with QuickTime file format of Apple Computer Inc. According to the QuickTime file format, the attribute information is called Movie Resource. Similarly, in Movie Resource, the access map information is called the Sample Table.

One video object is composed of one attribute information file, and one or a plurality of video files, and it is assumed that they are associated with each other based on file names. More specifically, it is assumed that an attribute information file and a video file are associated with each other by setting a portion of a file name excluding an extension to be the same (e.g., in the video media object 310, by setting a portion “ABCD0001” to be the same between the attribute information file and the video file, these files are associated with each other).

The association between the attribute information file and the video file is not limited to the above method. Other methods may be used, such as holding, in an attribute information file, link information to an associated video file (e.g., a path name to the video file, etc.), holding the association between the attribute information file and the video file as table information, and the like. One video object may contain one attribute information file and one or a plurality of files other than a video file. Alternatively, an attribute information file and a video file are integrated so that one file constitutes a video object.

Among the media objects, regarding a still image object containing still image data of the JPEG or the like, each still image information is recorded as a still image file “ABCDnnnn.JPG” or the like. The still image file is image data compressed by the JPEG system of the like, and is recorded, for example, as a file in the DCF format, the Exif format, or the like.

The above-mentioned media object is recorded in accordance with the DCF standard or a directory structure similar thereto. More specifically, under the ROOT directory 300, a DCIM image root directory 302 (directory name: DCIM) is placed, and under the DCIM image root directory 302, a DCF directory 305 (directory name: 300ABCDE) for storing a still image file is placed. Then, under the DCF directory 305, a DCF basic file 311 (e.g., file name: ABCD0001.JPG) that is a kind of a still image object is stored.

Furthermore, under the ROOT directory 300, a VIDEO image root directory 301 (directory name: VIDEO) is placed, and under the VIDEO image root directory 301, a VIDEO directory 304 (e.g., directory name: 100ABCDE) for mainly storing a video object is placed. Under the VIDEO directory 304, an attribute information file (file with an extension MOI) and a video file (file with an extension MPG) constituting a video media object 310 are stored.

As a media object, AV files in other file formats, such as an audio file compressed by AC-3, AAC, etc., a non-compressed audio file, a MotionJPEG file, a DCF extended image file defined by the DCF standard, a DCF thumbnail file, a PNG file, and the like, may be recorded.

Contents management information for managing recorded media objects is recorded as a media object manager 320 (file name: MOI_MGR) and a program manager 330 (file name: PRG_MGR) under a management data directory 303 (directory name: INFO). The configurations of the media object manager 320 and the program manager 330 will be described later. The recorded positions of the media object manager 320 and the program manager 330 are not limited to those under the management data directory 303. For example, they may be recorded under the VIDEO image root directory 301, or the like.

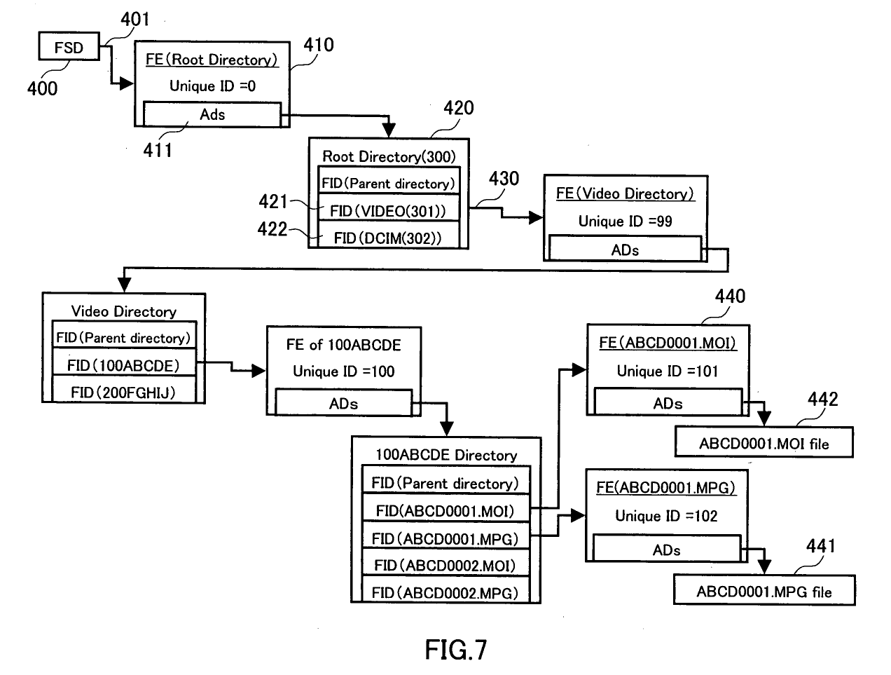

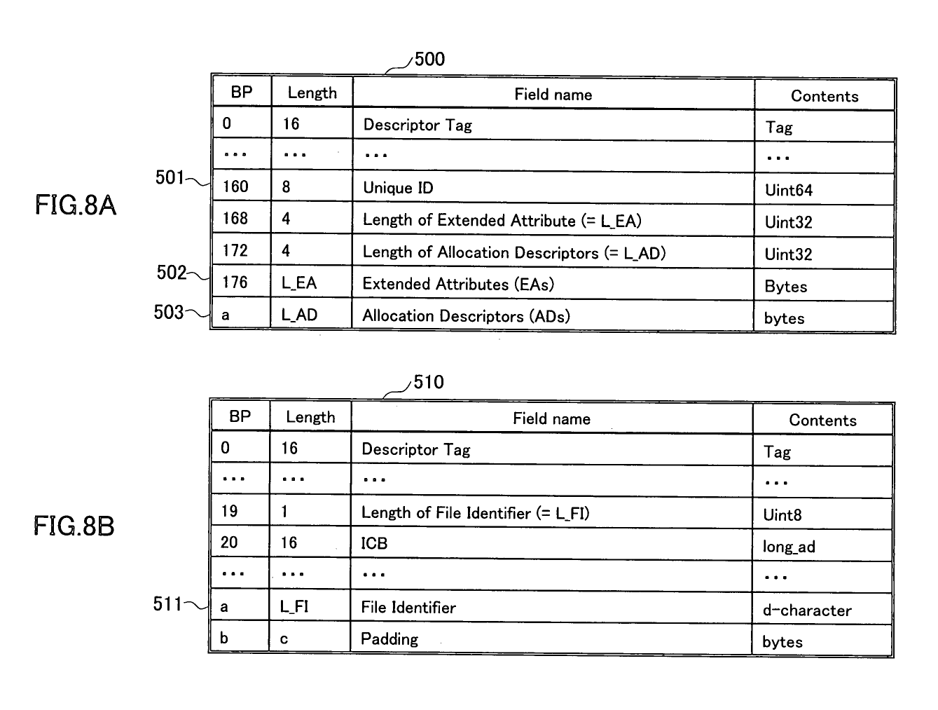

Next, the data structure of a UDF file system for managing, as a file, data on a disk medium used in the recording/reproducing apparatus according to Embodiment 1 of the present invention will be described with reference to FIGS. 7 and 8. FIG. 7 shows a data structure for managing a directory hierarchy in the UDF file system. FIG. 7 corresponds to the directory hierarchical structure shown in FIG. 6. However, FIG. 7 shows only file system information from the ROOT directory 300 to the video media object 310. Similar information on the other directories and files is omitted for simplicity.

A start point of the directory hierarchical structure is a File Set Descriptor (FSD) 400. The FSD 400 holds reference information 401 (recorded position on the disk medium 100) with respect to a File Entry (FE) 410.

Furthermore, the FE 410 has a structure shown in FIG. 8A. A FE 500 is an organization for managing the collection of extents constituting each directory and file recorded on the disk medium 100, and has a structure called Allocation Descriptors (ADs) 503 since it manages a recorded position on the disk medium 100 of each extent and a data length.

In addition, the FE 500 includes a Descriptor Tag representing the kind of data, a Unique ID 501 for setting a unique ID value that is not duplicated on the disk medium 100 on a directory and file basis, Extended Attributes (EAs) 502 capable of setting an extension attribute on the basis of the FE 500, and the like.

An extent 420 containing directory data of the ROOT directory 300 and the like is composed of a File Identifier Descriptor (FID) 510 for holding the names of each directory and file. In the case where subdirectories and files are present under a certain directory, the FID 510 is held with respect to each directory or file.

For example, referring to FIG. 6, under the ROOT directory 300, the VIDEO image root directory 301, and the DCIM image root directory 302 are placed. Therefore, in the extent (actual data) 420 of the ROOT directory 300, FIDs 421 and 422 corresponding to each directory are held.

The FID 510 has a configuration shown in FIG. 8B. The FID 510 holds the names of each directory and file managed on the UDF as a File Identifier 511. The FID 510 also holds, as ICB, reference information (e.g., 430) with respect to the FE 500 managing the actual data of corresponding directories and files.

In addition, the FID 510 includes a Descriptor Tag representing the kind of data, a Length of File Identifier representing the length of data of the File Identifier 511, and the like.

Thereafter, by similarly holding a reference relationship between the FE 500 and the FID 510, a directory hierarchical structure is managed, and by following the reference relationship, an extent that is actual data of an arbitrary directory or file can be accessed.

Regarding files, the collection of extents is managed by the FE 500. In this case, the collection of extents constitute video data 441 and attribute information data 442, which correspond to the video media object 310 in FIG. 6.

The above-mentioned FSD 400, the FE 500, and the FID 510 are placed in the partition space in FIG. 5. In the UDF, an Extended File Entry (EFE) having the same function as that of the FE 500, and having additional attributes and additional functions called a named stream are defined. The named stream is used to store additional extended attributes. According to the present invention, the description has been made using the FE 500; however, the EFE may be used in place of the FE 500.

In order to refer to a particular directory or file in a file system having the above-mentioned hierarchical structure, a path name can be used. The path name is expressed, for example, as “/VIDEO/100ABCDE/ABCD001.MOI” with respect to the attribute information file 442 in FIG. 7. Herein, the ROOT directory 300 and a path delimiter are expressed by “/”.

Thus, the path name describes names of directories (information stored in the File Identifier 511) present in a path from the ROOT directory 300 to a directory or file of interest through a directory hierarchy, in a series, while delimiting a plurality of directory names with a path delimiter. If the path name is used, an arbitrary directory or file managed on a file system can be referred to.

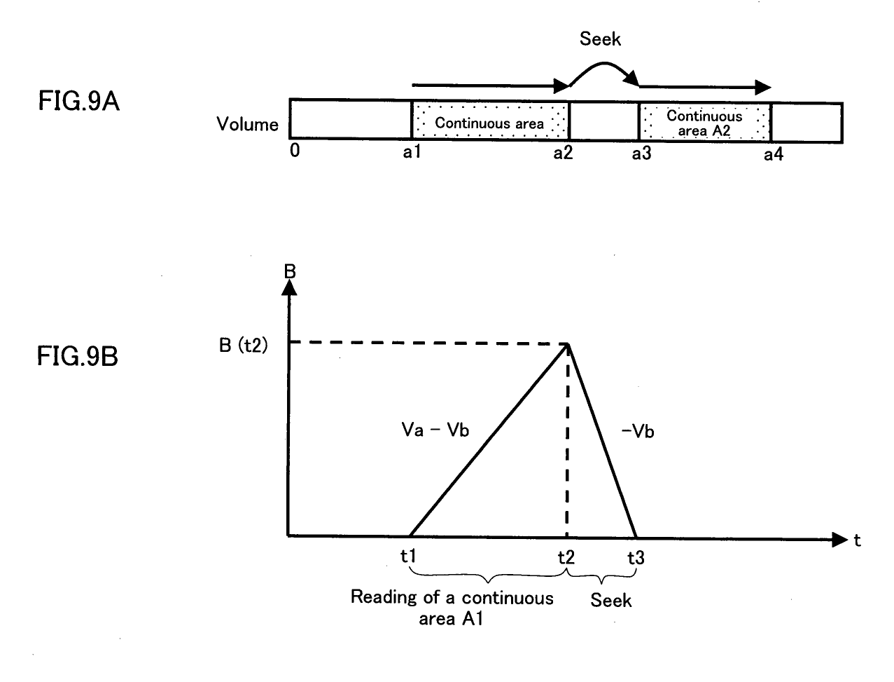

Next, the operation of the recording/reproducing apparatus according the present embodiment, for recording information onto the disk medium 100, will be described. First, referring to FIG. 9, the dispersion arrangement of AV data on the disk medium 100 will be described. More specifically, by effectively using the track buffer 103 in the system as shown in FIG. 2, AV data can be placed discretely.

FIG. 9A is a diagram showing an address space on the disk medium 100. In FIG. 9A, it is assumed that an address value is 0 at a left end, and increases rightward. Furthermore, “0”, a1 to a4 represent address values at each position.

As shown in FIG. 9A, in the case where AV data is recorded separately in a continuous area A1 of [a1, a2] and a continuous area A2 of [a3, a4], by supplying data accumulated in the track buffer 103 to the video decoder 240 while the optical pickup 101 is performing a seek operation from a2 to a3, AV data can be reproduced continuously.

FIG. 9B shows the state at this time. AV data that starts being read at the position a1 is input to the track buffer 103 from a time t1, and at the same time, data starts being output from the track buffer 103. Because of this, data is accumulated in the track buffer 103 by a rate difference (Va−Vb) between an input rate (Va) to the track buffer 103 and an output rate (Vb) from the track buffer 103. This state continues until the optical pickup 101 reaches a2 (i.e., until a time t2).

Assuming that the amount of data accumulated in the track buffer 103 during the above period is B(t2), the amount of data B(t2) accumulated in the track buffer 103 may be consumed and continued to be supplied to the video decoder 204 during a period from the time t2 to a time t3 when reading of data in an area a3 starts.

In other words, if the data amount ([a1, a2]) to be read before seeking is kept at a predetermined amount or more, even in the case where seeking occurs, AV data can be supplied continuously.

The size of a continuous area to which AV data can be supplied continuously is obtained when converted to ECC block number N_ecc by the following Expression:

N_{—}ecc=Vb×Tj/((N_{—}sec×8×S_size)×(1−Vb/Va))

where N_sec is the number of sectors constituting an ECC block, S_size is a sector size, and Tj is seek performance (maximum seek time).

Furthermore, a defective sector may be generated in a continuous area. Considering this case, the size of a continuous area to which AV data can be supplied continuously is determined by the following Expression:

N_{—}ecc=dN_{—}ecc+Vb×(Tj+Ts)/((N_{—}sec×8×S_size)×(1−Vb/Va))

where dN_ecc is a size of an acceptable defective sector, and Ts is a time required for skipping the defective sector in a continuous area.

In Embodiment 1, the case where data is read from the disk medium 100 i.e., reproducing) has been described. However, the case of recording data onto the disk medium 100 i.e. recording) also can be considered in the same way as in reproducing.

As described above, in the disk medium 100, when at least a predetermined amount of data is recorded continuously, even if AV data is recorded discretely on a disk, it can be reproduced continuously. For example in a DVD, a continuous area is called a CDA. Alternatively, the continuous area may be called an AV extent, since it is a special extent for recording AV data.

Next, the operation of the recording/reproducing apparatus according to Embodiment 1 will be described with reference to FIG. 3. The recording/reproducing apparatus shown in FIG. 3 starts its operation, for example, when the user I/F part 200 receives a request from a user.

The user I/F part 200 transmits the request from the user to the system control part 104. The system control part 104 interprets the request from the user and requests each module to process the request.

Hereinafter, the operation of encoding a signal according to the analog broadcasting to MPEG-2 PS, and recording it as a video object (i.e., a recording operation of so-called self-encoding) will be exemplified.

The system control part 104 requests the analog broadcasting tuner 210 to receive an AV signal and requests the video encoder 221 to encode the AV signal. The video encoder 221 subjects the AV signal transmitted from the analog broadcasting tuner 210 to video-encoding, audio-encoding, and system-encoding, to transmit the encoded AV signal to the track buffer 103. After starting encoding, the video encoder 221 transmits information required for creating access map information and the like to the system control part 104 in parallel with the encoding processing.

Next, the system control part 104 transmits a recording request to the drive device 110. The drive device 110 obtains data accumulated in the track buffer 103 and records it in the disk medium 100. At this time, the above-mentioned continuous area CDA is searched for from a recordable area on a disk, and data is recorded in the searched continuous area.

At this time, the search for a recordable area as a CDA is performed based on an unallocated space information managed by a file system such as a UDF (e.g., Space Bitmap Descriptor).

The end of recording is designated by a stop request from the user. The recording stop request from the user is transmitted to the system control part 104 through the user I/F part 200. The system control part 104 transmits an encoding stop request to the analog broadcasting tuner 210 and the video encoder 221. The video encoder 221 receives the encoding stop request from the system control part 104 to end the encoding processing.

After ending the encoding processing, the system control part 104 generates attribute information containing access map information, its management information, and the like, based on the information received from the video encoder 221.

Then, the system control part 104 requests the drive device 110 to end recording of data accumulated in the track buffer 103 and to record attribute information. The drive device 110 records the remaining data in the track buffer 103 and the attribute information on the disk medium 100, as an attribute information file (e.g., ABCD001.MOI that is a file constituting the video object shown in FIG. 6), and ends the recording processing of the video object.

In addition, the system control part 104 generates and updates information of the UDF file system as described in FIGS. 7 and 8, if required. More specifically, the system control part 104 generates FE500 and FID510 with respect to files constituting the video object, sets required information, and records the FE500 and FID510 on the disk medium 100.

In the case where the recording/reproducing apparatus is a camera apparatus, the processing is the same as described above, except that the camera part 211 is used as an AV signal source, instead of the analog broadcasting tuner 210.

Furthermore, in an operation of recording a signal according to the digital broadcasting as a video object, the system control part 104 controls in such a manner that video data is not encoded, and data of MPEG2 TS is recorded on the disk medium 100 as a video object through the digital broadcasting tuner 212 and the analyzing part 223. At this time, file system information also is recorded, in the same way as in self-encoding.

Next, regarding recording of a still image object, the operation of subjecting an AV signal transmitted from the camera part 211 to JPEG-encoding and recording the encoded signal will be described.

The system control part 104 requests the camera part 211 to output an AV signal, and requests the still image encoder 222 to encode the AV signal. The still-image encoder 222 subjects the AV signal transmitted from the camera part 211 to JPEG encoding, and transmits the encoded AV signal to the track buffer 103.

While receiving an instruction from the system control part 104, the drive device 110 records data accumulated in the track buffer 103 on the disk medium 100. At this time, a recordable area of data is searched for, based on an unallocated space information managed by a file system such as a UDF.

When one still image object is recorded, photographing is ended. Alternatively, in the case where there is an instruction of continuous photographing from a user, photographing is ended based on a stop request from the user, or photographing is ended when a predetermined number of still image objects are recorded.

A photographing stop request from the user is transmitted to the system control part 104 through the user I/F part 200, and the system control part 104 transmits a stop request with respect to the camera part 211 and the still image encoder 222.

Furthermore, the system control part 104 also performs required processing with respect to information of the UDF file system. More specifically, the system control part 104 generates FE500 and FID 510 with respect to a file constituting a still image object, sets required information, and records them on the disk medium 100.

Each media object recorded on the disk medium 100 by the above-mentioned procedure is registered in the media object manager 320 shown in FIG. 6, for the purpose of classifying and organizing media files, and reproducing a program later.

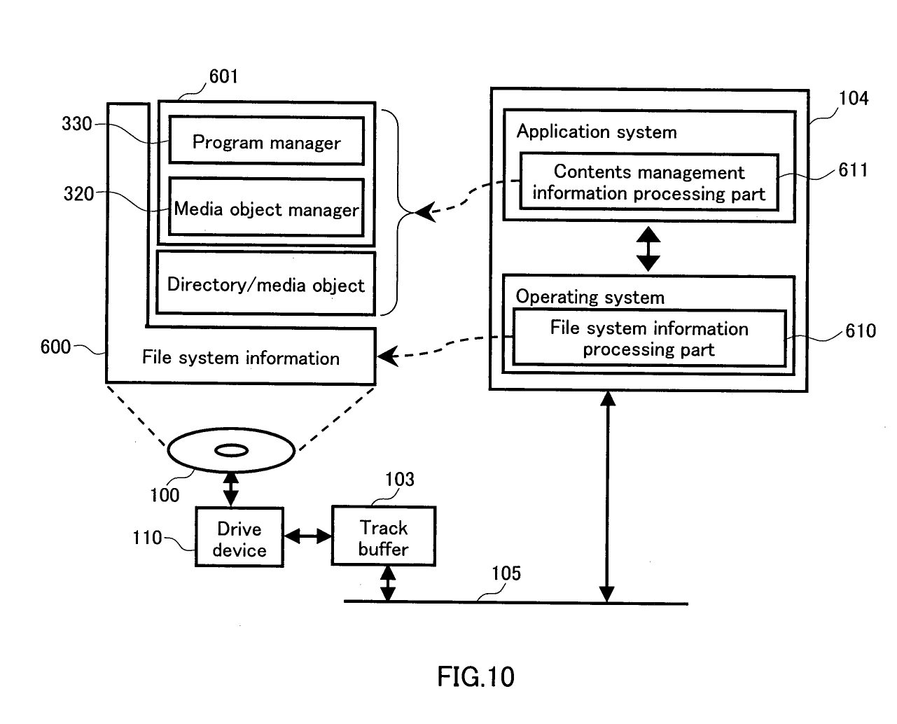

FIG. 10 is a diagram showing an example of a hierarchical structure of data to be recorded on the disk medium 100 used in the recording/reproducing apparatus according to Embodiment 1, the system control part 104 for processing the data, and an internal structure thereof.

File system information 600 is recorded on the disk medium 100. The file system information 600 includes the volume structure information 290 shown in FIG. 5, the FSD 400, the FE 500, and the FID 510 shown in FIGS. 7 and 8, and the above-mentioned Space Bitmap Descriptor, and the like.

Furthermore, the media object manager 320 and the program manager 330 for classifying and organizing the media objects in accordance with the contents thereof, recorded date and time, etc., and performing programmed reproduction in which a user sets a reproducing order freely, also are managed as files.

The data recorded on the disk medium 100 is operated by the system control part 104 through the system bus 105.

The system control part 104 specifically is composed of an operating system (OS) and an application system. The operating system includes a file system information processing part 610 for controlling the file system information 600, a device driver part for controlling hardware (not shown), and a memory control part (not shown), etc., and provides various common functions to the application system through an Application Program Interface (API). Because of this, the application system can be realized separately from hardware and the detail of a file system.

On the other hand, in the application system, a control operation for a particular application is performed. In Embodiment 1, for example, as described with reference to FIG. 3, recording/reproducing processing of a video object or a still image object is controlled.

Furthermore, in Embodiment 1, a contents management information processing part 611 in the application system operates contents management information 601 composed of the media object manager 320 and the program manager 330.

It also is considered that the application system includes parts for displaying AV data, processing a user interface, etc., if required.

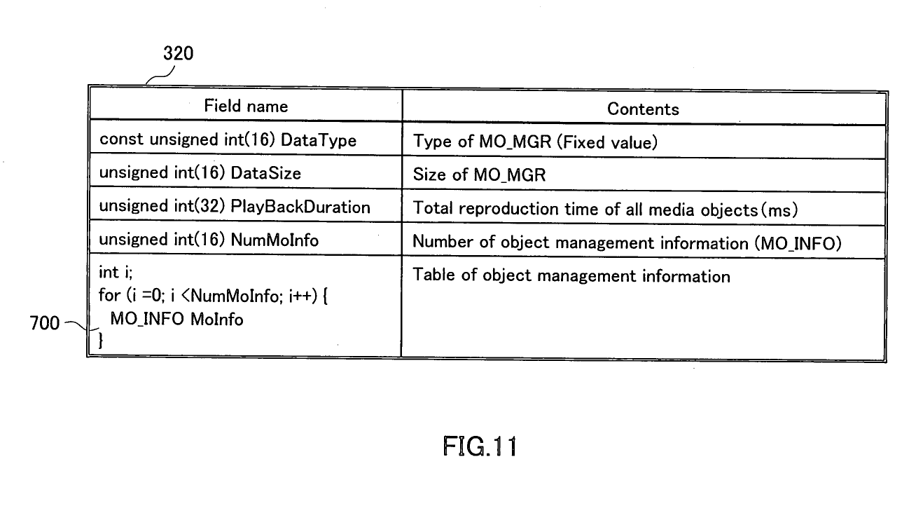

The data structure of the media object manager 320 and the program manager 330 will be described with reference to FIGS. 11 to 14.

FIG. 11 is a diagram illustrating a data structure of the media object manager 320. As shown in FIG. 11, the media object manager 320 is a table of object management information including DataType representing the type of a file, DataSize representing the size of a file, PlayBackDuration representing the total of reproduction times of all the media objects registered in the media object manager 320, NumMoInfo representing the number of object management information (MO_INFO) 700 contained in the media object manager 320, and NumMoInfo pieces of Mo_INFO 700.

In a column of a field name in FIG. 11 and the like, a data type and a field name are described continuously. The data type means, for example, the following: “const” means that a field is a constant; the absence of “const” means that a field is a variable; “unsigned” means that a field has a value with no sign; and the absence of “unsigned” means that a field has a value with a sign. Furthermore, into means that a field is an integer having a bit length in parentheses. For example, in the case where the value in parentheses is “16”, the bit length is 16.

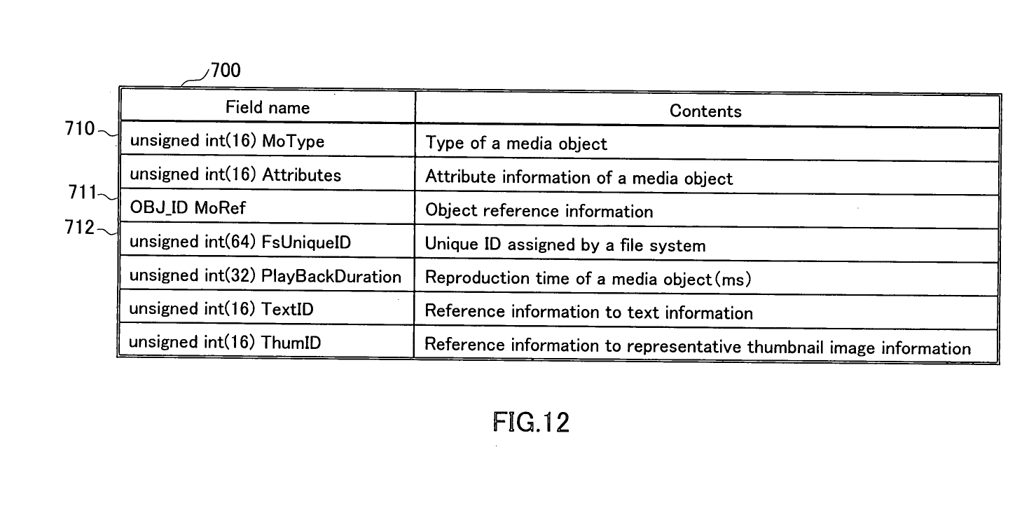

FIG. 12 shows a data structure of object management information (MO_INFO) 700 contained in the media object manager 320. The MO_INFO 700 is composed of MoType 710 representing the type information of a media object to be registered, object reference information MoRef 711 that is reference information with respect to a media object, FsUniqueID 712 to which the same value as that of the unique ID 501, assigned to a file constituting the media object on a file system, is set, and the like.

In addition, the MO_INFO 700 includes Attributes representing various kinds of attributes information, PlayBackDuration that is a reproduction time of the media object, reference information TextID with respect to text information stored in a place different from that of the MO_INFO 700, reference information ThumID with respect to thumbnail information stored in a place different from that of the MO_INFO 700, and the like.

A value commonly set with respect to the unique ID 501 and the FsUnique ID 712 will be referred to as a unique ID. The MO_INFO 700 also may be called a Property Entry. Furthermore, information represented by MoType 710 and MoRef 711 also may be called a Binary File Identifier.

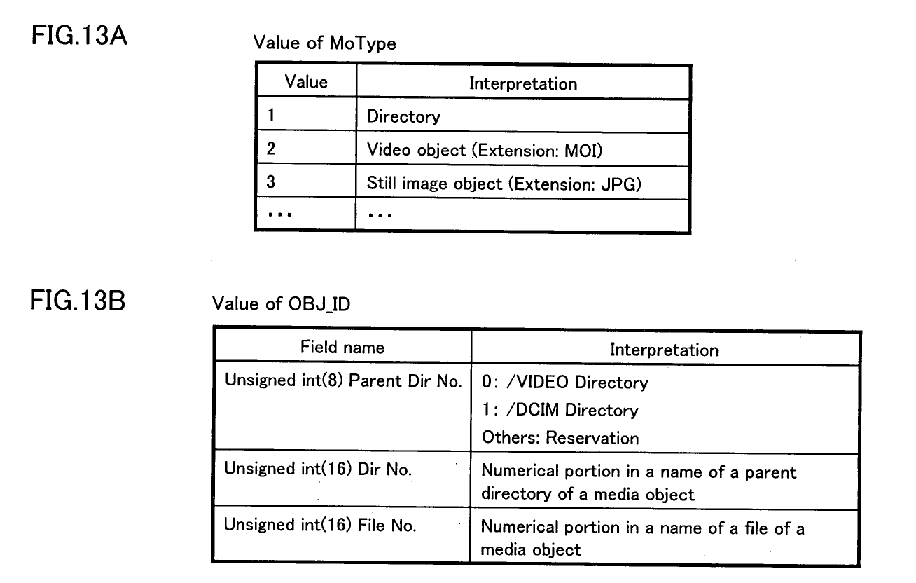

As shown in FIG. 13A, the value set with respect to the MoType 710 is determined by the kind of a media object to be referred to. In the case where the value of MoType is 1, the kind of a media object registered in certain object media information is a directory on a file system. Similarly, in the case where the value is 2, the kind of a media object is a video object (extension: MOI). In the case where the value is 3, the kind of a media object is a still image object (extension: JPG). Similarly, depending upon the kind of a media object, different values of MoType are assigned.

Furthermore, the value set with respect to the MoRef 711 is determined by converting path name information of a media object to be referred to, in accordance with a conversion rule shown in FIG. 13B. A first field Parent DIR No is determined based on a path name of a parent directory of a media object to be referred to by the MO_INFO 700. More specifically, in the case where the VIDEO image root directory 301 is a parent directory, the most significant bit is 0. In the case where the DCIM image root directory 302 is a parent directory, the most significant bit is 1. The other values are not used in Embodiment 1, so that they are defined as reserved values. Needless to say, values given by the conversion rule may have another combination. For example, the VIDEO image root directory 301 may be assigned 1, the DCIM image root directory 302 may be assigned 2, and the other values may be assigned reserved values.

In the subsequent field Dir No, a directory number of a media object registered in the MO_INFO 700 is extracted to be stored. Herein, the directory number refers to a numerical portion in a directory name of a parent directory of a media object.

In the subsequent field File No, a file number of a media object registered in the MO_INFO 700 is extracted to be stored. Herein, the file number refers to a numerical portion in a file name of a media object.

For example, in the case where a path name of a media object is “/VIDEO/100ABCDE/ABCD0001.MOI”, the media object has a /VIDEO directory as a parent directory, so that the value of Parent Dir No of OBJ_ID is “0”, and the value of a numerical portion of a parent directory name of the media object is “100”. Therefore, the value of Dir No of OBJ_ID is “100”. Furthermore, the value in the numerical portion of the file name of the media object is taken, whereby the value of File No of OBJ_ID is “0001”.

Thus, the value set with respect to the MoType 710 is 1. Furthermore, the value set with respect to the MoRef 711 is 0/100/0001 according to a notation arranged in the order of Parent Dir No, Dir No, and File No, using “/” as a delimiter. Hereinafter, the value of OBJ_ID will be shown according to the similar notation, if required.

Even when OBJ_ID is in the above-mentioned format, if a naming rule, in which names of media objects and values in numerical portions contained in names of parent directories are not duplicated as in a naming rule under the DCF standard, is complied with, a media object referred to by the MoRef 711 can be specified on a file system, together with extension information derived from the above-mentioned value of the MoType 710. Such a configuration is preferable for the purpose of reducing the amount of data of the MO_INFO 700.

Needless to say, the data structure of OBJ_ID may be in any format, as long as the MO_INFO 700 can be associated with a media object uniquely. For example, the path information of a media object may be stored as it is. That is, a character string of a full-path name using “/” as a path delimiter as in “/VIDEO/100ABCDE/ABCD0001.MOI” may be stored. Alternatively, an extension of a file may be stored in place of the MoType 710. For example, regarding a file “/VIDEO/100ABCDE/ABCD0001.MOI”, “MOI” may be stored.

Regarding a video object, only an attribute information file (e.g., ABCD0001.MOI in FIG. 6) may be registered in object management information. This is because it is possible to know a corresponding video file (in this case, ABCD0001.MPG in FIG. 6) from an attribute information file based on the association and the like of file names as described above. Alternatively, a video file may be registered in object management information. This is because it is possible to know a corresponding attribute information file similarly.

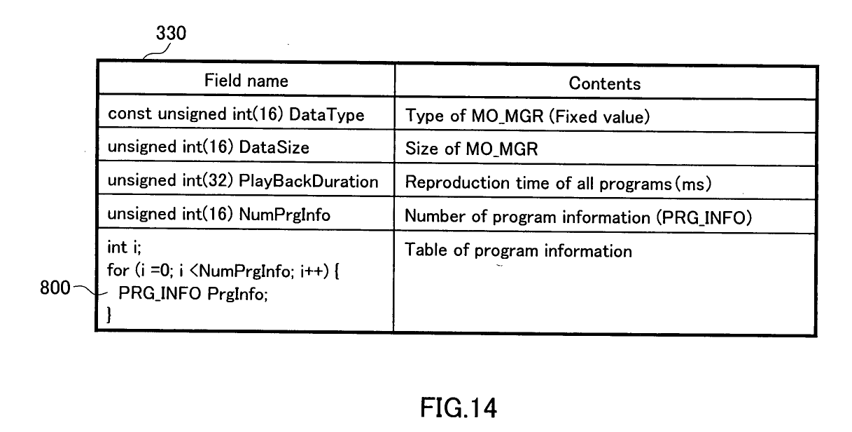

Next, FIG. 14 is a diagram illustrating a data structure of the program manager 330. In FIG. 14, the program manager 330 is a file provided so as to group arbitrary media objects to classify and organize them, realize the function of reproducing programs in the order desired by a user, and the like.

As shown in FIG. 14, the program manager 330 is composed of a table of program information including DataType representing the type of a file, DataSize representing the size of a file, PlayBackDuration that is the total of reproduction times of all the media objects registered in the program manager 330, NumPrgInfo representing the number of program information (PRG_INFO) 800 contained in the program manager 330, and NumPrgInfo pieces of PRG_INFO 800.

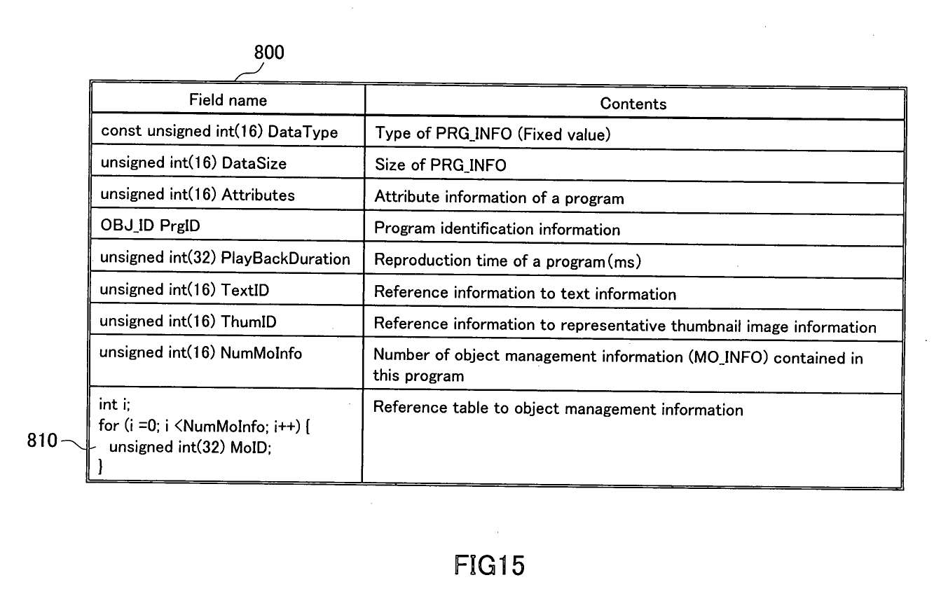

FIG. 15 shows a data structure of the PRG_INFO 800 contained in the program manager 330. As shown in FIG. 15, the PRG_INFO 800 is composed of a reference table with respect to the MO_INFO 700 or the like, including DataType representing that the PRG_INFO 800 is program information, DataSize representing the size of the PRG_INFO 800, Attributes representing various kinds of attribute information of a program, PlayBackDuration that is a reproduction time of a program, NumMoInfo representing the number of references with respect to the MO_INFO 700 contained in the PRG_INFO 800, and NumMoInfo pieces of MoID 810.

In addition, the PRG_INFO 800 may include reference information Text ID with respect to text information, reference information ThumID with respect to thumbnail information, and the like stored in a place different from that of the PRG_INFO 800.

The PRG_INFO 800 groups the MO_INFO 700, and classifies a plurality of media objects recorded on the disk medium 100. Because of this, a virtual folder structure can be configured independently from a directory structure on a file system, and media objects can be classified freely. Alternatively, by successively reproducing media objects referred to by the PRG_INFO 800, programmed reproduction can be performed. The PRG_INFO 800 also may be called a Favorite Folder.

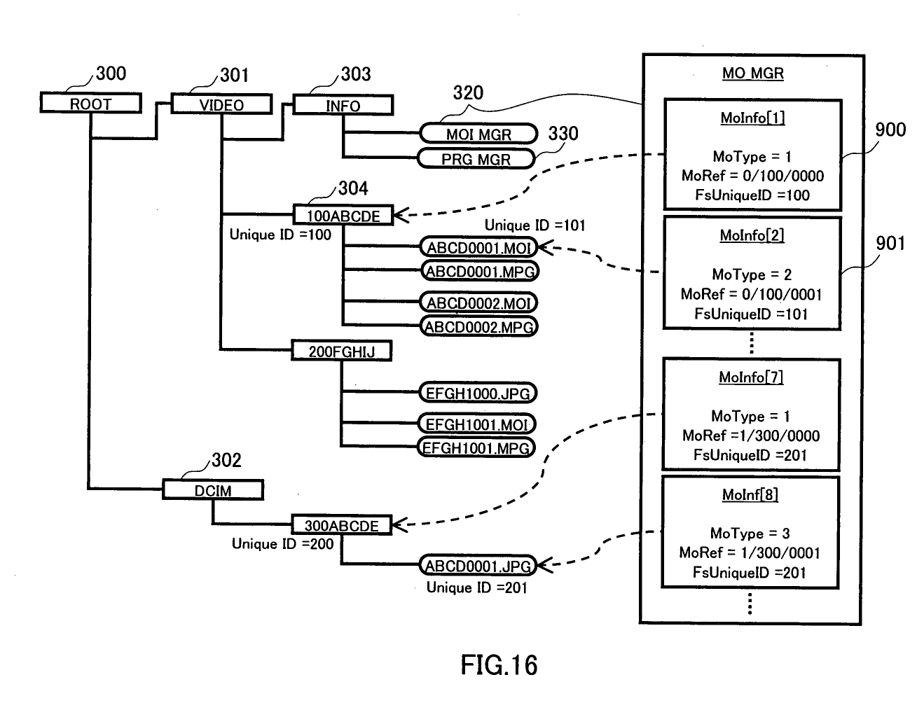

Next, the relationship between the directories and media objects managed by a file system, and the MO_INFO 700 will be described with reference to FIG. 16.

As described with reference to FIG. 8, directories and files on a UDF file system respectively are assigned values of the unique ID 501. For example, it is assumed that the VIDEO directory 304 in FIG. 16 is assigned “100” as a value of the unique ID 501. The value of the unique ID 501 is held in the FE 500 (not shown in FIG. 16). It is assumed that all the directories and files shown in FIG. 16 (including those which are not shown) are assigned values of the unique ID 501.

On the other hand, in the media object manager 320, a plurality of MO_INFO 700 are included, and a media object is registered in each MO_INFO 700. For example, in MoInfo[1] 900, the directory 304 is registered. The value of a field of the MoInfo[1] 900 is set as follows.

First, as the value of MoType, “1” representing a directory is set as shown in FIG. 13A. Then, in the MoRef 711, a parent directory “0”, a directory number “100”, and a file number “0000” are set as shown in FIG. 13B, and an entire field value is 0/100/0000.

In the FsUniqueID 712, “100” that is the same value as that of the unique ID 501 of a corresponding UDF file system is set.

Furthermore, the value of a field of MoInfo[2] 901 is set as follows. First, “2” representing a video object is set in MoType. In the MoRef 711, a parent directory “0”, a directory number “100”, and a file number “0001” are set, and an entire field value is 0/100/0001.

In the FsUniqueID 712, “101” that is the same value as that of the unique ID 501 of a corresponding UDF file system is set. Thereafter, in other MoInfo, values are set similarly.

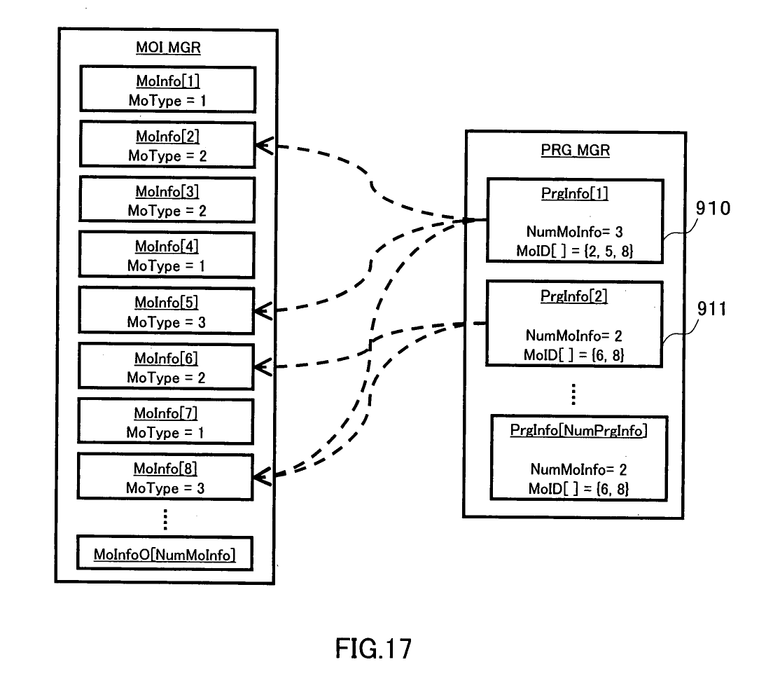

FIG. 17 shows the relationship of the program manager 330 with respect to the media object manager 320. As described above, the program manager 330 includes a plurality of PRG_INFO 800.

Each PRG_INFO 800 holds reference information with respect to the MO_INFO 700 as its index value or the like. For example, in PrgInfo[1] 910, since MoInfo[2], MoInfo[5], and MoInfo[8] are represented by broken arrows in FIG. 17, 2, 5, and 8 are held as table values of MoID. Similarly, in PrgInfo[2] 911, since MoInfo[6] and MoInfo[8] are referred to, 6 and 8 are held as table values of MoID.

As reference information with respect to the MO_INFO 700, a value of FsUniqueID in each MO_INFO 700 may be used in place of an index value. In this case, for example, in a table value of MoID of the PrgInfo[1] 910, “100” is held as reference information with respect to the MoInfo[2]304.

When directories and media objects are recorded on the disk medium 100, the file system information processing part 610 operates the file system information 600, as described with reference to FIG. 10. More specifically, when directories and files are created newly on a file system, the file system information processing part 610 creates the FID 510 and the FE 500, and determines the arrangement of extents.

The file system information processing part 610 also sets values, which are not duplicated on the disk medium 100, with respect to the respective unique IDs 501. Furthermore, the contents management information processing part 611 operates the contents management information 601. More specifically, the contents management information processing part 611 creates new MO_INFO 700 for registering a file created by the file system information processing part 610, in the media object manager 320.

Then, the contents management information processing part 611 obtains information from the file system information processing part 610, if required, and sets values in such a manner as not to cause a contradiction between the file system information 600 and the information in the media object manager 320. For example, regarding the MoRef 711, path name information of a file is obtained, and a value obtained by converting the value of the path name information in accordance with the conversion rule shown in FIG. 13B is set. Regarding the FsUniqueID 712, the value of the unique ID 501 assigned by the file system information processing part 610 is set.

Thus, by using the program manager 330, and information of the media object manager 320 referred to by the program manager 330, a program of a media object can be reproduced correctly, and the like.

However, as described in the prior art, there is a possibility that the file system information 600 may be changed easily with a general file system on a PC, by an operation of a user or the like.

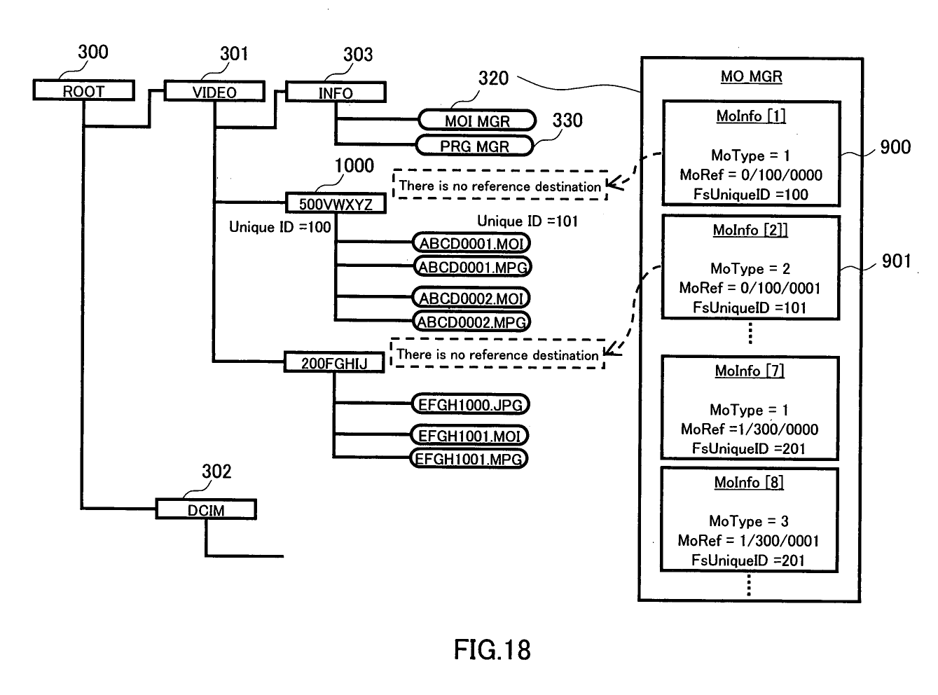

For example, as shown in FIG. 18, it is assumed that the directory 304 (directory name 100ABCDE) in FIG. 16 has been changed to a directory 1000 (directory name 500VWXYZ). In this case, inconsistency of information is caused among the file system information 600, the contents management information 601, and the MO_INFO 700.

More specifically, the value of the MoRef 711 of the MoInfo[1] 900 is not matched with the path name of an actual directory. Similarly, even in the MoInfo[2] referring to a media object under the directory 1000, the value of the MoRef 711 is not matched with the path name. Accordingly, there is no reference destination from the MoInfo[1] and MoInfo[2].

Even in such a state, before and after a directory is changed as shown in FIG. 18, the values of the unique IDs 501 of respective directories and files are not changed. As shown in FIG. 8, the names of the respective directories and files are stored in the file identifier 511 of the FID 510, whereas the unique IDs 501 are stored in the FE 500. Therefore, when a directory name or a file name is changed, only the value of the file identifier 511 is updated.

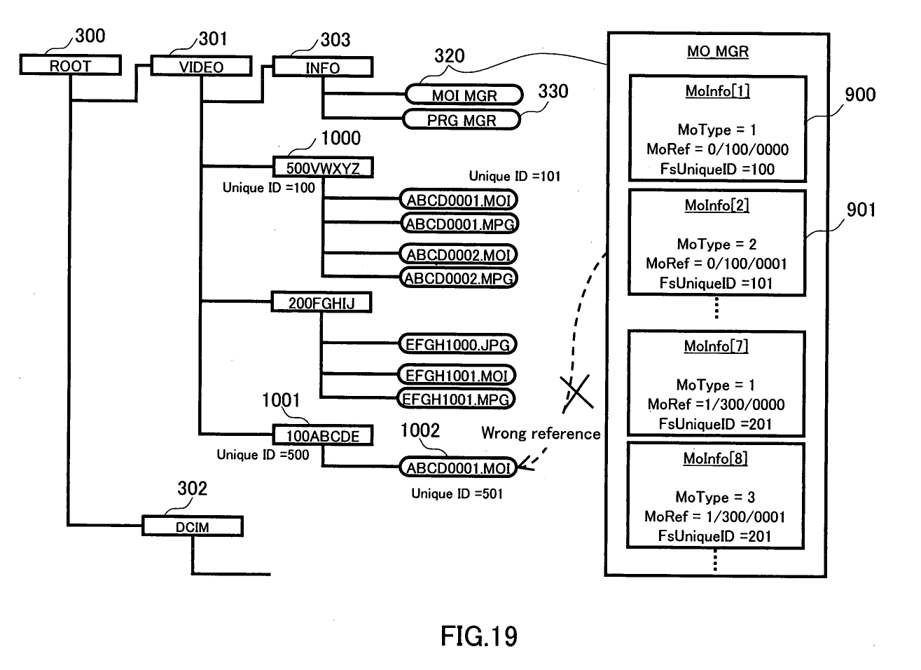

Furthermore, the following also is considered: a directory and a file are added newly in the state shown in FIG. 18, whereas the media object manager 320 and the program manager 330 are not operated. FIG. 19 shows this state.

In FIG. 19, assuming that the names of an added directory 1001 and an added file 1002 are 100ABCDE and ABCD001.MOI, the value of the MoRef 711 of the MoInfo[2] 901 happens to be matched therewith.

More specifically, as in a reference provided with an “X” mark in FIG. 19, the MoInfo[2] 901 refers to the file 1002, in spite of the fact that the MoInfo[2] 901 has no intention to do so. If the information of the MoInfo[2] 901 is presented to a user, and as a result, its reproduction is designated, a media object that is not intended at all may be reproduced.

Then, the system control part 104 in the recording/reproducing apparatus according to Embodiment 1 performs recovery processing with respect to the media object manager 320 by the contents management information processing part 611.

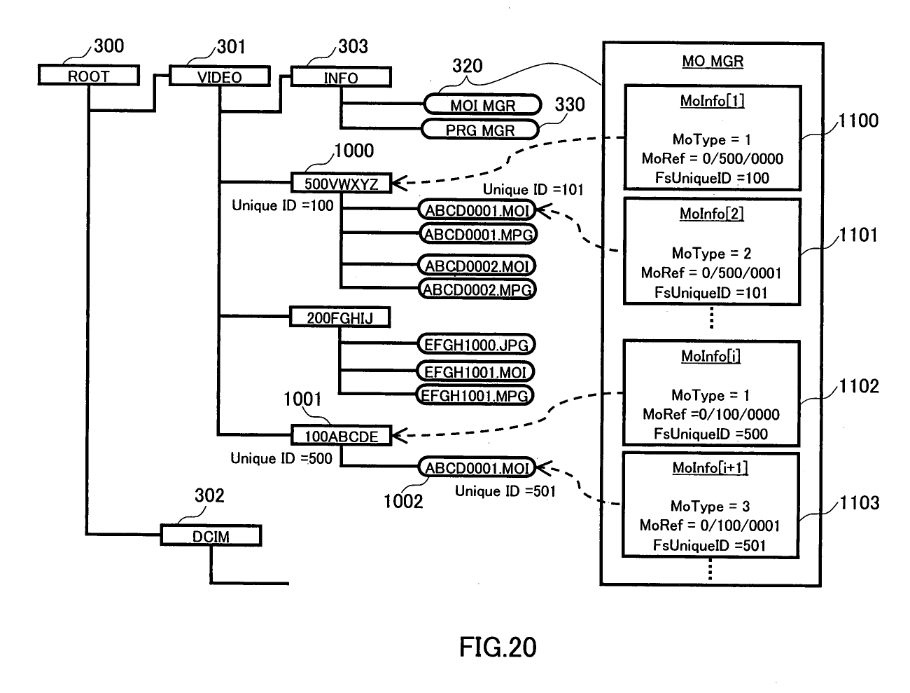

More specifically, the contents management information processing part 611 rewrites the MoInfo[1] 900 in FIG. 18 or 19 as in the MoInfo[1] 1100 in FIG. 20. More specifically, the value of the MoRef 711 is corrected so that the directory 1000 can be correctly referred to from the MoInfo[1] 1100.

At this time, whether or not the directory 1000 is associated with the MoInfo[1] 1100 is determined by comparing the unique ID 501 in the file system information with the value of the FsUniqueID 712 in the object management information.

In the example shown in FIG. 20, it can be determined that the directory 1000 is associated with the MoInfo[1] 1100, since the values of both of them are “100”. Then, the contents management information processing part 611 sets a new value of the MoRef 711 of the MoInfo[1] 1100 from the name of the directory 1000.

This also is applicable to the MoInfo[2] 1101. The contents management information processing part 611 changes the value of the MoInfo[2] 1101 so that a media object in which the unique ID 501 and the FsUniqueID 712 have the same value “101” is associated with MO_INFO. Consequently, a reference relationship as represented by a broken line in FIG. 20 can be obtained.

Furthermore, regarding the directory 1001 and the file 1002, the corresponding MO_INFO 700 is not present in the media object manager 320. Therefore, the contents management information processing part 611 newly adds MoInfo[i] 1102 and MoInfo[i+1] 1103. Herein, whether or not the MO_INFO 700 corresponding to a certain directory and a certain file is present in the media object manager 320 can be determined by checking whether the MO_INFO 700 having the same value as that of the unique ID 501 of the directory and the file is present in the media object manager 320.

In the case of the example shown in FIG. 20, the MO_INFO 700 having “500” and “501” that are values of the unique ID 501 of the directory 1001 and the file 1002 is not supposed to be present. Therefore, the contents management information processing part 611 newly adds MoInfo[i] 1102 and MoInfo[i+1] 1103. At this time, the contents management information processing part 611 sets the value of the MoRef 711 from the path name of the directory 1001 and the file 1002, and obtains the values of the unique ID 501 on the file system, thereby setting the values of the unique ID 501 to be “500” and “501”.

Due to the above-mentioned processing, the inconsistency between the file system information 600 and the media object manager 320 can be corrected.

It also is considered that a file and a directory of a corresponding reference destination are not present any more with respect to predetermined MO_INFO 700. More specifically, in the case where a value of the FsUniqueID 712 of certain MO_INFO 700 is searched for with respect to all the FEs 500 recorded on the disk medium 100 and is not found, the directory or file referred to by the MO_INFO 700 is not present any more on the disk medium 100. In such a case, the MO_INFO 700 is deleted from the media object manager 320.

As a result of the above-mentioned deletion, an unnecessary media object is not presented to a user, which can avoid confusion of the user.

The media object manager 320 may perform registration in the MO_INFO 700 in such a manner as to manage only directories and files under a particular directory such as the VIDEO image root directory 301 and the DCIM image root directory 302, instead of managing all the directories and files on the disk medium 100.

In this case, when the value of the FsUniqueID 712 is searched for with respect to the FE 500, and the like, a search target can be limited to directories and files under a subdirectory managed by the media object manager 320.

In the above description, the case where the unique ID 501 and the FsUniqueID 712 are set to be the same value has been described. The unique ID 501 is unsigned 64-bit data, so that it can be expressed up to a very large numerical value. Therefore, even by setting lower 32 bits of the unique ID 501 with respect to the FsUniqueID 712, the same effects as those described above can be obtained depending upon the condition. More specifically, this corresponds to the case where, even if the FsUniqueID 712 is set to be 32-bit data, media objects merely are generated to such a degree that their values are not duplicated. In this case, the MO_INFO 700 can be composed of a smaller amount of data.

Furthermore, as the value of the unique ID to be set in the FsUniqueID 712, the value of a field UDFUniqueID stored in ICB of FID 510 may be set, instead of the unique ID 512.

The UDFUniqueID is defined as a field in which lower-order 32 bits of the unique ID 512 of the FE 500 referred to by the FID 510 are set, and this value can be used as the unique ID.

Embodiment 2

In Embodiment 2, a method for providing a unique ID different from that in Embodiment 1 will be described. In Embodiment 2, the unique ID set in the contents management information 601 by the contents management information processing part 611 is reflected in the file system information 600 side via the file system information processing part 610.

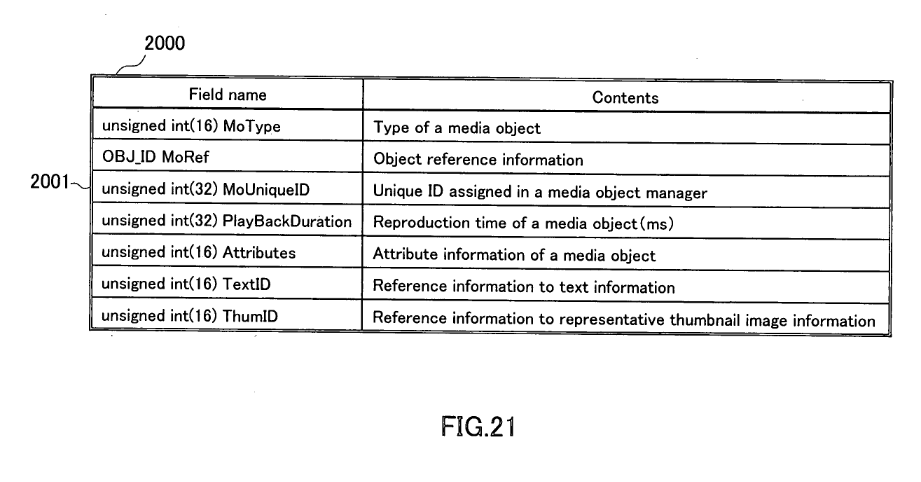

FIG. 21 is a diagram illustrating a data structure of MO_INFO 2000 in a recording/reproducing apparatus according to Embodiment 2 of the present invention. The MO_INFO 2000 is different from the MO_INFO 700 shown in FIG. 12, in that MoUniqueID 2001 is provided in place of the FsUniqueID 712.

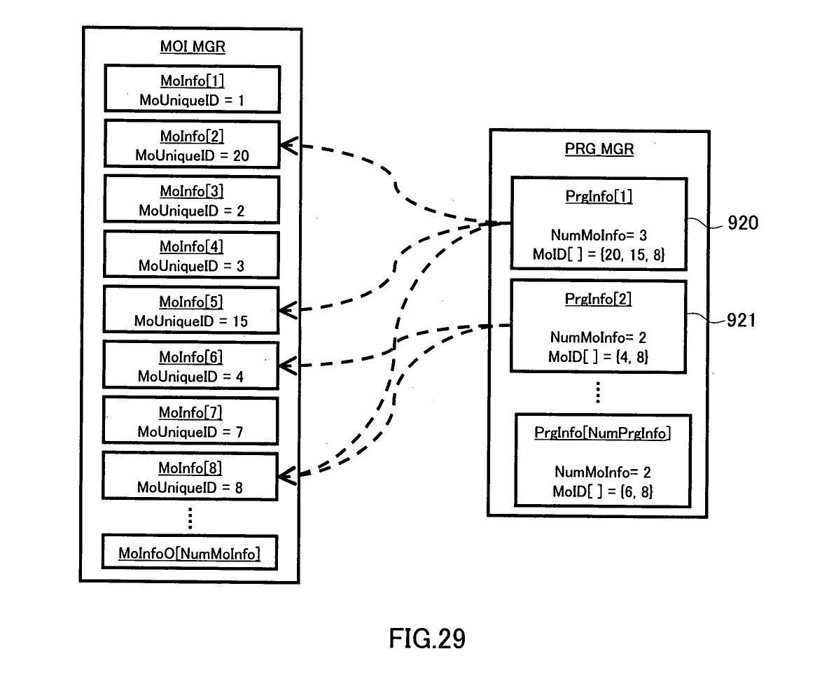

The MoUniqueID 2001 is the same as the unique ID 501, in that values thereof are not duplicated on the disk medium 100. However, the MoUniqueID 2001 is different from the unique ID 501, in that the contents management information processing part 611 manages a setting value, and provides an actual value. The MO_INFO 2000 also may be called a Property Entry. The MoUniqueID 2001 also may be called an Entry_Number. In the present embodiment, as reference information from each PRG_INFO 800 to the MO_INFO 2000, the value of the MoUniqueID 2001 may be used in place of an index value. For example, as shown in FIG. 29, PrgInfo[1] 920 refers to MoInfo[2], MoInfo[5], and MoInfo[8], so that the PrgInfo[1] 920 holds 20, 15, and 8 as table values of MoID. Similarly, PrgInfo[2]921 refers to MoInfo[6] and MoInfo[8], so that the PrgInfo[2] 921 holds 4 and 8 as table values of MoID.

In Embodiment 2, when a new directory and a new media object (file) are recorded on the disk medium 100, and they are registered in the media object manager 320, the contents management information processing part 611 sets the value of the MoUniqueID 2001.

The contents management information processing part 611 sets the value, which is set in the MoUniqueID 2000, in the file system information 600 via the file system information processing part 610. More specifically, the same value as that set in the MoUniqueID 2001 is set in EAs 502 shown in FIG. 8A.

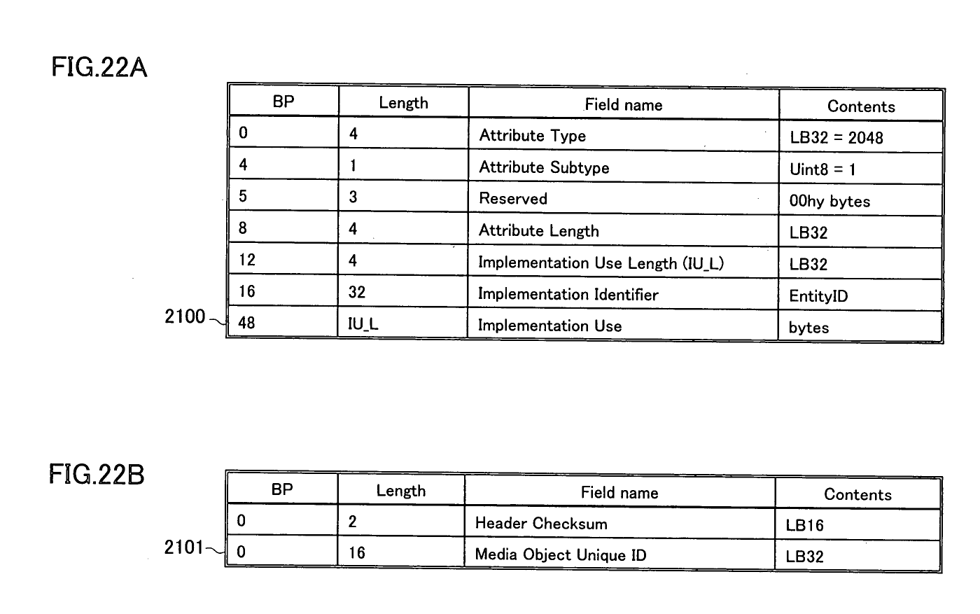

The EAs 502 is an area for storing an extended attribute defined by a UDF file system, and can be used by an application system and the like, if required. FIG. 22A shows a structure called an Implementation Use Extended Attribute contained in the EAs 502.

In the Implementation Use Extended Attribute, fields called an Attribute Type and an Attribute Subtype are present, and by setting appropriate values in these fields, it is possible to identify which application system uses an extended attribute contained in the Implementation Use Extended Attribute.

The value of an actual extended attribute is stored in an Implementation Use 2100 that is a variable-length field, the length of which is represented by an Implementation Use Length (IU_L). The data structure of extended attributes to be stored in the Implementation Use 2100 is determined on the basis of an application using the extended attributes.

In Embodiment 2, a data structure shown in FIG. 22B will be exemplified. More specifically, the MoUniqueID 2001 is set in a Media Object Unique ID 2101.

Thus, along with the creation of a media object, a unique ID shared by the contents management information 601 and the file system information 600 is set.

Consequently, in the same way as described in Embodiment 1, even if inconsistency is caused between the contents management information 601 and the file system information 600 by changing a directory name and a file name without changing contents management information, by comparing the value of the MoUniqueID 2001 with the value of the Media Object Unique ID 2101, the inconsistency can be detected and corrected easily.

Furthermore, it also is possible to know whether or not a certain directory and a certain file are registered in the contents management information 601 by searching for the value of the Media Object Unique ID 2101 in the media object manager 320.

Alternatively, in the case of recording a directory and a file on the disk medium 100 using a UDF file system not corresponding to extended attributes as shown in FIG. 22B, it is possible to know whether or not the directory and the file are registered in the media object manager 320 merely by seeing the FE 500 that manages the directory and the file. More specifically, when the presence/absence of extended attributes of the data structure shown in FIG. 22B is checked in the FE 500, and there are no corresponding extended attributes, it can be determined that the directory and the file are not registered in the media object manager 320. Thus, when such a file and a directory are detected, it is considered that there is inconsistency between the file system information 600 and the contents management information 601. Then, the inconsistency can be corrected and a warning can be displayed to a user, and a recording operation can be stopped.

Embodiment 3

As described above, in Embodiments 1 and 2, a method has been described in which the value of the unique ID is stored in the file system information 600 and the contents management information 601, whereby the detection of inconsistency therebetween and the recovery of consistency are facilitated.

In Embodiment 3, a method will be described in which values other than that of the unique ID are stored in the file system information 600 and the contents management information 601, whereby inconsistency therebetween is detected.

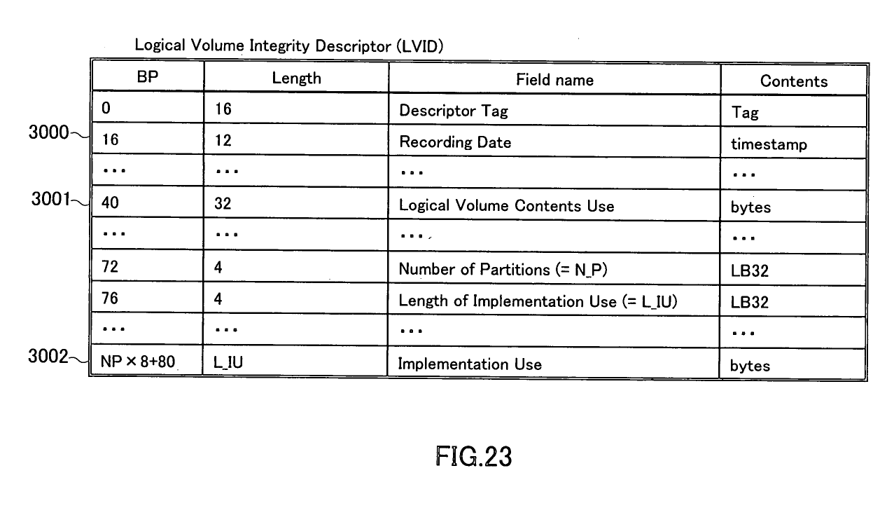

FIG. 23 shows a structure of a Logical Volume Integrity Descriptor (LVID) defined by a UDF file system. The LVID has a field called a Recording Date 3000 recorded in the volume structure information 290 shown in FIG. 6 and representing the last recorded date of the file system information 600 with respect to a corresponding volume space.

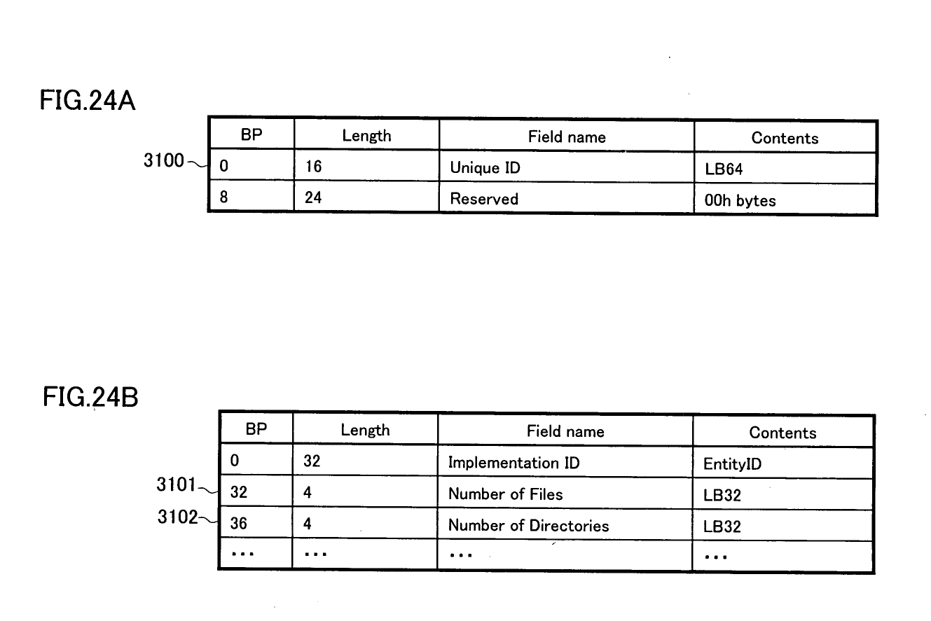

Furthermore, in the Logical Volume Contents Use, the data shown in FIG. 24A is stored, and in an Implementation Use 3001, the data shown in FIG. 24B is stored. FIG. 24A shows a structure called a Logical Volume Header Descriptor of Logical Volume Contents Use, and a unique ID 3100 is stored therein.

The unique ID 3100 is a field for storing a maximum value at all times, with respect to a value assigned to the unique ID 501 of each directory or file in the file system information 600. When the file system information processing part 610 creates a new file or the like, the value of the unique ID 3100 is referred to, and a value larger than the value of the unique ID 3100 is newly set as that for the unique ID 501 to be set for a new file, whereby values of the unique ID 501 are not duplicated on the disk medium 100.

On the other hand, FIG. 24B shows a structure called an Implementation Use. In the Implementation Use, there are Number of Files 3101 and Number of directories 3102. The number of Files 3101 represents the total number of files contained in the file system information 600, and the number of Directories 3102 represents the total number of directories contained in the file system information 600.

When the file number or the directory number recorded on the disk medium 100 is changed, the value of the Number of Files 3101 and the number of Directories 3102 also are updated by the file system information processing part 610.

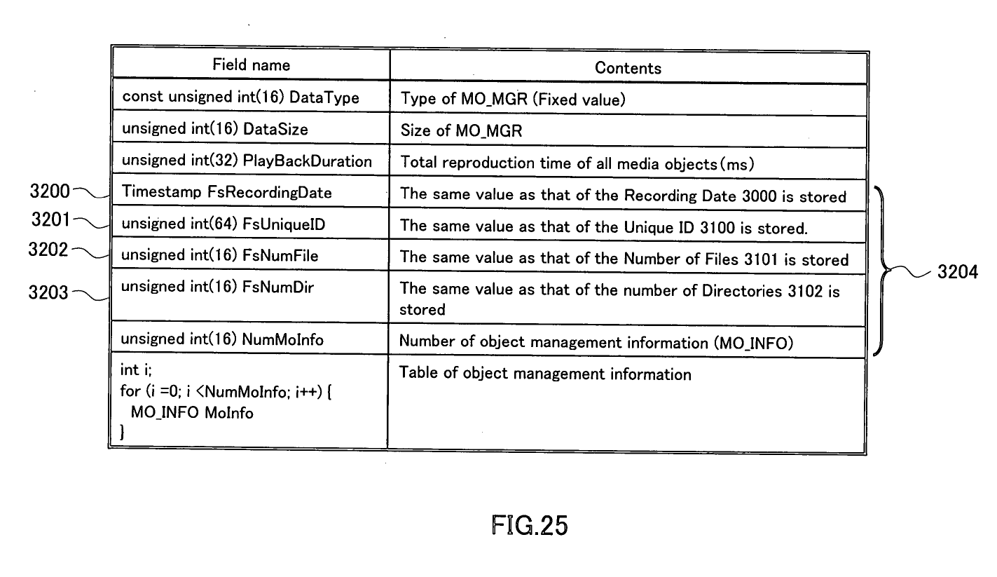

FIG. 25 is a diagram illustrating a data structure of the media object manager 320 in the recording/reproducing apparatus according to Embodiment 3 of the present invention. The media object manager 320 shown in FIG. 25 is different from that shown in FIG. 11, in that the following fields are added.

That is, FsRecordingDate 3200, FsNumFile 3202, and FsNumDir 3203 are added. Four fields including these fields and FsUniqueID 3201 collectively are called volume update information 3204.

The FsRecordingDate 3200 is a field in which the same value as that of the above-mentioned RecordingDate 3000 is set. The FsUniqueID 3201 is a field in which the same value as that of the above-mentioned unique ID 3100 is set. The FsNumFile 3202 is a field in which the same value as that of the above-mentioned Number of Files 3101 is set. The FsNumDir 3203 is a field in which the same value as that of the above-mentioned Number of Directories 3102 is set.

In the same way as described with reference to the unique ID in Embodiment 1, when the values of the Recording Date 3000 and the like are set by the file system information processing part 610, the contents management information processing part 611 obtains these values and sets them in the FsRecordingDate 3200. This also is applicable to the other volume update information 3204.

Because of the above, in the case where only the file system information 600 is rewritten, inconsistency between the file system information 600 and the contents management information 601 can be detected. More specifically, when either field of the volume update information 3204 to be matched is not matched with the value of a corresponding field in the volume structure information 290, it can be determined that only the file system information 600 has been rewritten.

If the inconsistency between the file system information 600 and the contents management information 601 is detected, by checking the values of the unique ID between the respective directories and files, and object reference information, a place of inconsistency can be detected in more detail, and consistency therebetween can be recovered, as described in Embodiment 1 and the like.

Furthermore, by notifying a user of the occurrence of inconsistency, and stopping a recording operation if the user is recording information, the confusion of the user can be minimized.

Embodiment 3 can be performed simultaneously with Embodiment 1 or 2. However, even if Embodiment 3 is performed independently, it is possible to know easily the presence/absence of inconsistency with respect to the entire disk.

In any of the above embodiments, a recording/reproducing apparatus and a recording medium have been described, mainly, by exemplifying an optical disk medium such as a DVD. However, the present invention is not particularly limited thereto. Recording apparatuses such as a hard disk drive using a magnetic recording medium, and recording media such as an magneto-optical disk medium may be used.

Furthermore, as the contents management information 601, an example has been described in which the media object manager 320 and the program manager 330 are configured as two independent files. However, they may be configured as one file having both functions. Furthermore, the contents management information 601 may be configured so as to contain file contents different from those of the media object manager 320, for storing the volume update information 3204.

As described above, in the recording/reproducing apparatus according to the embodiments of the present invention, a unique ID is held in file system information and contents management information in the course of recording of a media object. Therefore, even if inconsistency is caused between the file system information and the contents management information as a result of inappropriate processing such as an operation of only the file system information, by comparing the values of the unique ID, a file and a directory that are subjected to an inappropriate operation can be detected easily, and consistency between the file system information and the contents management information can be recovered easily.

Furthermore, by recording particular information in the volume structure information contained in file system information, in contents management information, inconsistency between the file system information and the contents management information can be detected easily.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A recording/reproducing apparatus, comprising:
a recording/reproducing part for recording or reproducing information with respect to a recording medium;
a file system information processing part for managing the information to be recorded or reproduced by the recording/reproducing part as a file, using file system information having a directory hierarchical structure capable of being referred to by a path name; and
a contents management information processing part for managing the directory and the file, using contents management information containing object management information referred to by object reference information on the path name,
wherein, when information on the recording medium is updated by the recording/reproducing part, the file system information processing part records information on the update in the file system information, and
the contents management information processing part records the same information as the information on the update in the object management information.

2. The recording/reproducing apparatus according to claim 1, wherein, in a case where a new directory or a new file is recorded on the recording medium, the directory or the file is assigned a unique ID that is identification information not duplicated on the recording medium, and the assigned unique ID is used as the information on the update.

3. The recording/reproducing apparatus according to claim 2, wherein the file system information processing part records the unique ID in an extended attribute in a file entry managing a structure of the directory or the file, and
the contents management information processing part records the unique ID in the object management information so that the unique ID is associated with object reference information.

4. The recording/reproducing apparatus according to claim 1, wherein a value of the unique ID is determined by the file system information processing part.

5. The recording/reproducing apparatus according to claim 1, wherein a value of the unique ID is determined by the contents management information processing part.

6. The recording/reproducing apparatus according to claim 2, wherein, in a case where the directory or the file referred to by the object reference information is detected not to be present in the directory hierarchy,
the contents management information processing part searches the file system information for the same value as that of the unique ID recorded in the object management information, and when a directory or a file assigned the same value as that of the unique ID is detected, the contents management information processing part sets new object reference information in the object management information with respect to a path name of the directory or the file assigned the same value as that of the unique ID.

7. The recording/reproducing apparatus according to claim 1, wherein, in a case where the directory or the file referred to by the object reference information is detected not to be present in the directory hierarchy,
the contents management information processing part searches the file system information for the same value as that of the unique ID recorded in the object management information, and when a directory or a file assigned the same value as that of the unique ID is not detected, the contents management information processing part deletes the object management information from the contents management information.

8. The recording/reproducing apparatus according to claim 1, wherein, in a case where information in a volume managed by the file system information is updated by the recording/reproducing part on the recording medium,
the file system information processing part updates volume update information contained in volume structure information managed by the file system information, and
the contents management information processing part records the same information as the volume update information in the contents management information.

9. The recording/reproducing apparatus according to claim 8, wherein the volume update information includes at least one selected from the group consisting of
(1) information representing a last update date and time of the volume;
(2) information representing a maximum value of a unique ID that is identification information not duplicated on the recording medium, contained in the file system information;
(3) a total number of files contained in the file system information; and
(4) a total number of directories contained in the file system information.

10. The recording/reproducing apparatus according to claim 8, wherein, in a case where the volume update information contained in the volume structure information managed by the file system information is not matched with the information in the contents management information,
the contents management information processing part searches the file system information for the same value as that of the unique ID recorded in the object management information, and when a directory or a file assigned the same value as that of the unique ID is detected, the contents management information processing part sets new object reference information in the object management information with respect to a path name of the directory or the file assigned the same value as that of the unique ID.

11. The recording/reproducing apparatus according to claim 8, wherein, in a case where the volume update information contained in the volume structure information managed by the file system information is not matched with the information in the contents management information,
the contents management information processing part searches the file system information for the same value as that of the unique ID recorded in the object management information, and when a directory or a file assigned the same value as that of the unique ID is not detected, the contents management information processing part deletes the object management information from the contents management information.

12. The recording/reproducing apparatus according to claim 8, wherein, in a case where the volume update information contained in the volume structure information managed by the file system information is not matched with the information in the contents management information, the recording/reproducing part stops recording of a new directory or a new file on the recording medium.

13. A recording/reproducing method for recording or reproducing information with respect to a recording medium by a recording/reproducing apparatus,
the information recorded or reproduced with respect to the recording medium being managed as a file, using file system information having a directory hierarchical structure capable of being referred to by a path name,
the directory and the file being managed, using contents management information containing object management information referred to by object reference information on the path name,
the recording/reproducing method comprising: when information on the recording medium is updated by the recording/reproducing apparatus,
recording information on the update in the file system information; and
recording the information on the update in the object management information.

14. The recording/reproducing method according to claim 13, further comprising, in a case where a new directory or a new file is recorded on the recording medium, assigning a unique ID that is identification information not duplicated on the recording medium to the directory or the file,
wherein the assigned unique ID is used as the information on the update in two processes of recording the information on the update.

15. The recording/reproducing method according to claim 14, wherein, in assigning the unique ID, a value of the unique ID is determined so as not to be duplicated in the file system information.

16. The recording/reproducing method according to claim 14, wherein, in assigning the unique ID, a value of the unique ID is determined so as not to be duplicated in the contents management information.

17. The recording/reproducing method according to claim 13, further comprising detecting whether or not the directory or the file referred to by the object reference information is present in the directory hierarchy,
the method further comprising: in a case where the directory or the file referred to by the object reference information is detected not to be present in the directory hierarchy, searching the file system information for the same value as that of the unique ID recorded in the object management information; and
when a directory or a file assigned the same value as that of the unique ID is detected, setting new object reference information in the object management information with respect to a path name of the directory or the file assigned the same value as that of the unique ID.

18. The recording/reproducing method according to claim 13, further comprising detecting whether or not the directory or the file referred to by the object reference information is present in the directory hierarchy,
the method further comprising: in a case where the directory or the file referred to by the object reference information is detected not to be present in the directory hierarchy, searching the file system information for the same value as that of the unique ID recorded in the object management information; and
when a directory or a file assigned the same value as that of the unique ID is not detected, deleting the object management information from the contents management information.

19. The recording/reproducing method according to claim 13, further comprising: in a case where information in a volume managed by the file system information is updated by the recording/reproducing apparatus on the recording medium,
updating volume update information contained in volume structure information managed by the file system information; and
recording the same information as the volume update information in the contents management information.

20. The recording/reproducing method according to claim 19, wherein the volume update information includes at least one selected from the group consisting of
(1) information representing a last update date and time of the volume;
(2) information representing a maximum value of a unique ID that is identification information not duplicated on the recording medium, contained in the file system information;
(3) a total number of files contained in the file system information; and
(4) a total number of directories contained in the file system information.

21. The recording/reproducing method according to claim 19, further comprising confirming whether or not the volume update information contained in the volume structure information managed by the file system information is matched with the information in the contents management information,
the method further comprising: in a case where the information is not matched, searching the file system information for the same value as that of the unique ID recorded in the object management information; and
when a directory or a file assigned the same value as that of the unique ID is detected, setting new object reference information in the object management information with respect to a path name of the directory or the file assigned the same value as that of the unique ID.

22. The recording/reproducing method according to claim 19, further comprising confirming whether or not the volume update information contained in the volume structure information managed by the file system information is matched with the information in the contents management information,
the method further comprising: in a case where the information is not matched, searching the file system information for the same value as that of the unique ID recorded in the object management information; and
when a directory or a file assigned the same value as that of the unique ID is not detected, deleting the object management information from the contents management information.

23. The recording/reproducing method according to claim 19, further comprising confirming whether or not the volume update information contained in the volume structure information managed by the file system information is matched with the information in the contents management information,
the method further comprising: in a case where the information is not matched, stopping recording of a new directory or a new file on the recording medium.

24. A computer program providing medium storing a computer program that is read by a computer and allows the computer to function as a recording/reproducing apparatus for recording or reproducing information with respect to a recording medium,
the information recorded or reproduced with respect to the recording medium being managed as a file, using file system information having a directory hierarchical structure capable of being referred to by a path name,
the directory and the file being managed, using contents management information containing object management information referred to by object reference information on the path name,
the computer program comprising an instruction for allowing the computer to perform the processes of: when information on the recording medium is updated by the computer,
generating information on the update;
recording the information on the update in the file system information; and
recording the information on the update in the object management information.

25. The computer program providing medium according to claim 24, wherein the computer program further comprises an instruction for allowing the computer to perform the process of, in a case where a new directory or a new file is recorded on the recording medium, assigning a unique ID that is identification information not duplicated on the recording medium to the directory or the file as the information on the update.

26. The computer program providing medium according to claim 24, wherein the computer program further comprises an instruction for allowing the computer to perform the processes of in a case where information in a volume managed by the file system information is updated by the computer on the recording medium,
updating volume update information contained in volume structure information managed by the file system information; and
recording the same information as the volume update information in the contents management information.

27. The computer program providing medium according to claim 24, the computer program further comprising an instruction for allowing the computer to perform the process of detecting whether or not the directory or the file referred to by the object reference information is present in the directory hierarchy,
in a case where the directory or the file referred to by the object reference information is detected not to be present in the directory hierarchy, searching the file system information for the same value as that of the unique ID recorded in the object management information; and
when a directory or a file assigned the same value as that of the unique ID is detected, setting new object reference information in the object management information with respect to a path name of the directory or the file assigned the same value as that of the unique ID.

28. The computer program providing medium according to claim 24, the computer program further comprising an instruction for allowing the computer to perform the process of detecting whether or not the directory or the file referred to by the object reference information is present in the directory hierarchy,
in a case where the directory or the file referred to by the object reference information is detected not to be present in the directory hierarchy, searching the file system information for the same value as that of the unique ID recorded in the object management information; and
when a directory or a file assigned the same value as that of the unique ID is not detected, deleting the object management information from the contents management information.

29. The computer program providing medium according to claim 26, the computer program further comprising an instruction for allowing the computer to perform the process of confirming whether or not the volume update information contained in the volume structure information managed by the file system information is matched with the information in the contents management information,
in a case where the information is not matched, searching the file system information for the same value as that of the unique ID recorded in the object management information; and
when a directory or a file assigned the same value as that of the unique ID is detected, setting new object reference information in the object management information with respect to a path name of the directory or the file assigned the same value as that of the unique ID

30. The computer program providing medium according to claim 26, the computer program further comprising an instruction for allowing the computer to perform the process of confirming whether or not the volume update information contained in the volume structure information managed by the file system information is matched with the information in the contents management information,
in a case where the information is not matched, searching the file system information for the same value as that of the unique ID recorded in the object management information; and
when a directory or a file assigned the same value as that of the unique ID is detected, deleting the object management information from the contents management information.

31. The computer program providing medium according to claim 26, the computer program further comprising an instruction for allowing the computer to perform the process of confirming whether or not the volume update information contained in the volume structure information managed by the file system information is matched with the information in the contents management information,
in a case where the information is not matched, stopping recording of a new directory or a new file on the recording medium.

32. A recording medium storing file system information having a directory hierarchical structure capable of being referred to by a path name, for managing information to be recorded or reproduced as a file, and
object management information referred to by object reference information on the path name, for managing the directory and the file,
wherein the file system information and the object management information contain information on an update of the information to be recorded or reproduced.

33. The recording medium according to claim 32, wherein the information on the update of the information to be recorded or reproduced is a unique ID as identification information assigned to an updated directory or file so as not to be duplicated with that of other directories or files on the recording medium.

34. The recording medium according to claim 32, wherein the information on the update of the information to be recorded or reproduced includes at least one selected from the group consisting of
(1) information representing a last update date and time of the volume managed by the file system information on the recording medium;
(2) information representing a maximum value of a unique ID that is identification information not duplicated on the recording medium, contained in the file system information;
(3) a total number of files contained in the file system information; and
(4) a total number of directories contained in the file system information.
